(19) United States
(12) Patent Application Publication
(10) Pub. No.: US 2005/0005043 A1
(43) Pub. Date: Jan. 6, 2005

(54) Controller and removable user interface (RUI) for media event and additional media content

(75) Inventors: Craig S. Gravina, Saratoga Springs, NY (US); Arthur A. Gravina, Naples, FL (US)

Correspondence Address: TILLMAN LAW OFFICE, PLLC, PO BOX 471581, CHARLOTTE, NC, 28247, US

(73) Assignee: PUSHPLAY INTERACTIVE, LLC, Saratoga Springs, NY (US)

(21) Appl. No.: 10/710,814

(22) Filed: Aug. 4, 2004

Related U.S. Application Data
(63) Continuation-in-part of application No. PCT/US03/34989, filed on Nov. 3, 2003.
(63) Continuation-in-part of application No. 10/605,868, filed on Nov. 1, 2003.
(63) Continuation-in-part of application No. 10/605,870, filed on Nov. 2, 2003.
Application No. PCT/US03/34989 is a continuation of application No. 10/605,868, filed on Nov. 1, 2003.
(60) Provisional application No. 60/423,161, filed on Nov. 1, 2002.
(60) Provisional application No. 60/423,161, filed on Nov. 1, 2002.
(60) Provisional application No. 60/423,161, filed on Nov. 1, 2002.
(60) Provisional application No. 60/571,900, filed on May 17, 2004.
(60) Provisional application No. 60/571,706, filed on May 17, 2004.
(60) Provisional application No. 60/571,746, filed on May 17, 2004.
(60) Provisional application No. 60/571,784, filed on May 17, 2004.
(60) Provisional application No. 60/571,745, filed on May 17, 2004.
(60) Provisional application No. 60/571,902, filed on May 17, 2004.
(60) Provisional application No. 60/571,750, filed on May 17, 2004.

(51) Int. Cl. G06F 13/12; G06F 3/00

(52) U.S. Cl. 710/73; 710/62; 710/63; 710/2

(57) ABSTRACT

An apparatus for controlling a media event and optionally presenting additional media content includes a removable user interface (RUI) having graphical indicia for guiding a user in selectively actuating a user input, and a controller capable of communicating commands to a media device responsively to the actuation of a user input. A determination of the location of a selector actuating a user input is made to interpret the selection of the user and to control a media event accordingly. The command sent by the controller depends on the selection of the user and Device Independent Instructions with regard to a selecting a media event, and depends on Device Dependent instructions with regard to controlling a particular media device of the host system to present the media event. Additional media content is optionally presented through a component of the controller.

### RELATED PATENT APPLICATIONS

The present application is a Continuation-In-Part application of, and claims the benefit of priority to each of co-pending U.S. non-provisional patent application No. 10/605,868 of Gravina et al., titled “Controller and Removable User Interface (RUI) for Media Presentation,” filed Nov. 1, 2003, which non-provisional patent application hereby is incorporated herein by reference and which claims priority under 35 U.S.C. 119 to U.S. provisional patent application No. 60/423,161 of Gravina, titled “SmartToys Multimedia Learning System,” filed Nov. 1, 2002, which provisional patent application is hereby incorporated herein by reference, co-pending U.S. non-provisional patent application No. 10/605,870 of Gravina et al., titled “Controller and Removable User Interface (RUI) for Controlling Media Event,” filed Nov. 2, 2003, which non-provisional patent application is hereby incorporated herein by reference and which claims priority under 35 U.S.C. 119(e) to U.S. provisional patent application No. 60/423,161 of Gravina, titled “SmartToys Multimedia Learning System,” filed Nov. 1, 2002; international patent application PCT/US2003/034989 of Gravina et al., titled “Controller and Removable User Interface (RUI) for Media Presentation,” filed under the Patent Cooperation Treaty (PCT) on Nov. 3, 2003, published in the English language as International Publication Number WO2004/042530A2, which international patent application is hereby incorporated herein by reference, and which is a continuation of and claims priority to U.S. non-provisional patent application No. 10/605,868 of Gravina et al., titled “Controller and Removable User Interface (RUI) for Media Presentation,” filed Nov. 1, 2003, and which international patent application claims priority to U.S. provisional patent application No. 60/423,161 of Gravina, titled “SmartToys Multimedia Learning System,” filed Nov. 1, 2002, and furthermore, the present application claims the benefit of priority under 35 U.S.C. 119 to each of U.S. provisional patent application No. 60/571,900 of Gravina et al., titled “Controller and Graphical User Interface (GUI) for Media Event,” filed May 17, 2004, which provisional patent application is hereby incorporated herein by reference, U.S. provisional patent application No. 60/571,706 of Gravina et al., titled “Controller and Peripheral User Interface (PUI) for Media Event,” filed May 17, 2004, which provisional patent application is hereby incorporated herein by reference, U.S. provisional patent application No. 60/571,746 of Gravina et al., titled “Controller having Conditional Programming Language for Media Event,” filed May 17, 2004, which provisional patent application is hereby incorporated herein by reference, U.S. provisional patent application No. 60/571,784 of Gravina et al., titled “Controller and User Interface (UI) for Media Event with User-Defined Instructions,” filed May 17, 2004, which provisional patent application is hereby incorporated herein by reference, U.S. provisional patent application No. 60/571,745 of Gravina et al., titled “Controller and User Interface (UI) for Multiple Media Events,” filed May 17, 2004, which provisional patent application is hereby incorporated herein by reference, U.S. provisional patent application No. 60/571,902 of Gravina et al., titled “Augmenting and Repurposing Media Content for Controller and User Interface (UI),” filed May 17, 2004, which provisional patent application is hereby incorporated herein by reference, and U.S. provisional patent application No. 60/571,750 of Gravina et al., titled “Controller and User Interface (UI) for Media Event with Accompanying Media Content,” filed May 17, 2004, which provisional patent application is hereby incorporated herein by reference.

### COPYRIGHT STATEMENT

All of the material in this patent document, including source code, is subject to copyright protection under the copyright laws of the United States and of other countries. The copyright owner has no objection to the facsimile reproduction by anyone of the patent document or the patent disclosure, as it appears in the Patent and Trademark Office patent file or records, but otherwise reserves all copyright rights whatsoever.

### COMPUTER PROGRAM LISTING APPENDIX

Submitted herewith and incorporated herein by reference are source code files comprising a computer program listing appendix. The computer program listing appendix includes source code for a script engine and source code for a compiler for compiling of script. The source code for the script engine is written in ANSI C, and the source code of the compiler is written in Visual Basic. The target hardware for this implementation is a PIC microprocessor, model number 18F8720. Forty-three computer listing files are submitted herewith as itemized on the Transmittal and as itemized in the table below. All files represent source code of the script engine except for those files as identified in the “Readme.txt” file and the “PushPlayScriptingAPI .txt” file.
tablereadwrite.h.txt
SendIrCommon.c.txt
i2c-ccs.c.txt
Form1.frm.txt
IStack.h.txt
SendIrRulesConfig.c.txt
SendIrRules.c.txt
FSDTableLarge.h.txt
delay.h.txt
FSDInterpreterTable.c.txt
SQueue.h.txt
serial.h.txt
beep.h.txt
support.h.txt
Support.c.txt
SendIrCommon.h.txt
i2c-ccs.h.txt
TestFsd.c.txt
RStack.c.txt
FSDCompileScript.cls.txt
CompileIrCodes.vbp.txt
SendIrUnivChip.c.txt
SendIrRules.h.txt
Eprom.c.txt
FSDInterpreterTable.h.txt
mainlinePic.c.txt
config.h.txt
PushPlayScriptingAPI.txt
RStack.h.txt
tablereadwrite.c.txt
SendIrUnivChip.h.txt
Readme.txt
Eprom.h.txt
Istackc.txt
CompileIrCodes.vbw.txt
PushPlayRules.c.txt
mainlinepic.h.txt
FSDTableLarge.c.txt
FastSimpleDocument.bas.txt
Delay.c.txt
SQueue.c.txt
serial.c.txt
beep.c.txt

### FIELD OF THE INVENTION

The field of the present invention generally relates to controlling media events with additional media content using a controller and a removable user interface (RUI) and, with regard to certain preferred embodiments, to controlling presentation of media content by a host system using a controller and a removable user interface (RUI) and presenting of media content by the controller. In this regard, a media event includes the displaying of video content and/or audio content, referred to herein as media presentation. Generally, however, a media event also may include the capturing, recording, transferring, and/or moving of video and/or audio content, depending upon the context.

### BACKGROUND OF THE INVENTION

As of 2002, the popularity of DVD players continues to grow and all indications suggest that sales will remain strong for years to come. Shipments of DVD players grew by 61% in 2002, reaching a total install base of over 40M US households. With a proliferation rate that makes the device the fastest adopted format in electronics history, most estimates predict an install base of at least 60M households by 2006. The DVD format, introduced in 1997, will likely be ubiquitous within 12 years, less than half the time it took for VCRs to reach that status.

Moreover, due to a growing desire to educate (and occupy) children through television and videos, families with children under four years old are now the highest video purchasing customers with an astonishing average of preschool home video market. Indeed, parents have been recently become particularly interested in educational videos for their youngest children, the infant/toddler segment. However, despite the undeniable appeal to children of videos, many parents in focus groups confessed unease at using videos with their youngest children due to the “passive” nature of the viewing. Unlike educational toys, in which the experience of the infants and toddlers is “hands on,” children may tend to lose interest in educational videos, especially when an educational video is highly repetitive, repeating one basic lesson over and over again with various puppets, cartoons, songs and so on (as most educational videos tend to do).

Accordingly, a need exists for an educational DVD video system that is interactive and, thereby, tends to maintain the attention and interest of children viewing the video. In this respect, and in accordance with one or more aspects of the present invention, a child viewing the video is able to interact, for example, by controlling educational segments of the video that are displayed; and/or by responding to questions presented in the video with appropriate responses indicating whether the response is correct.

While certainly broader in its utility, the present invention addresses this need with respect to certain preferred embodiments thereof, as described in detail below.

### SUMMARY OF THE INVENTION

Briefly described, the present invention relates to controlling a media event in a host system. For example, and not by way of limitation, the present invention may be utilized to control presentation in a home entertainment system of educational programming that is recorded on a DVD disk. In this example, the media event comprises the presentation, including navigation thereof, and the host system comprises the home entertainment system. Various aspects of the present invention now are briefly described in relation to controlling a media event in a host system.

### “RUI” Aspect of the Invention

In an aspect of the present invention, an apparatus for controlling a media event in a host system includes a controller and a user interface (UI) having user inputs. The apparatus further includes a machine readable medium having machine executable instructions specific to media content but not specific to any particular media device (“Device Independent Instructions”). Within this apparatus, the controller includes a processor, a program executed by the processor that interprets the Device Independent Instructions, and a library of software instructions accessible to the program for communicating by the controller to the host system, in a protocol of the host system, media device commands relating to the media event (“Device Specific Instructions”). The program, vis-à-vis the processor, in response to actuation of a user input of the UI, performs the steps of reading and/or interpreting Device Independent Instructions, accessing the Device Specific Instructions in the library based on the Device Independent Instructions read and/or interpreted, and communicating commands to the host system based on the Device Specific Instructions accessed from the library.

The machine readable medium having the Device Independent Instructions preferably comprises a controller-independent storage medium (CISM) capable of storing computer-executable instructions, and the controller preferably includes an interface for communicating with the CISM and reading the machine executable instructions therefrom. The CISM may comprise, for example, a removable memory cartridge, a memory disk, a read only memory (ROM) device, an erasable programmable read only memory (EPROM) device, any read only or read write memory device, an EEPROM or FLASH ROM device, an I2C standard device on a serial chip, or any magnetic or optical media memory storage device. The CISM may also communicate with the controller via contact points or wirelessly. Examples of a CISM may include a secure digital disk card, a multimedia card, and a memory stick. The CISM further may include, for example, a floppy disk, an optical disk, and a USB storage device.

In this aspect of the invention, the UI further comprises a removable user interface (RUI) that couples directly with the controller. The RUI further may include the CISM, having thereon the computer-readable medium for storing the Device Independent Instructions. In certain preferred embodiments set forth below in the detailed description of the invention, the RUI comprises a removable overlay that includes the CISM.

In commercial embodiments of this aspect, each RUI and CISM are packaged with the media content for which they are specifically developed to define a discrete media package, and the controller is sold separately and works with any such media package.

### “Overlay” Aspect of the Invention

In another aspect of the present invention, an apparatus for controlling a media event in a host system includes a controller in at least intermittent communication with a media device and an overlay that is removably coupled to the controller. The controller includes a processor for executing software instructions. The overlay includes a plurality of user inputs and a machine readable medium having machine executable instructions comprising commands for controlling media events, whereby an appropriate communication to the media device is determined by the processor of the controller upon actuation of a user input. In accordance with this particular aspect of the present invention, the user inputs are exposed for direct contact by a user in actuation thereof, with the actuation of a user input causing the communication from the controller to the media device; the machine executable instructions of the overlay may or may not be specific to any particular media content, and the commands may or may not be specific to any particular media device.

In commercial embodiments of this aspect, a controller may be sold separately from, and work with, various different overlays.

### “PUI” Aspect of the Invention

In an aspect of the present invention, an apparatus for controlling a media event in a host system includes a controller and a user interface (UI) having user inputs. The apparatus further includes a machine readable medium having machine executable instructions specific to media content but not specific to any particular media device (“Device Independent Instructions”). Within this apparatus, the controller includes a processor, a program executed by the processor that interprets the Device Independent Instructions, and a library of software instructions accessible to the program for communicating by the controller to the host system, in a protocol of the host system, media device commands relating to the media event (“Device Specific Instructions”). The program, vis-à-vis the processor, in response to actuation of a user input of the UI, performs the steps of reading and/or interpreting Device Independent Instructions, accessing the Device Specific Instructions in the library based on the Device Independent Instructions read and/or interpreted, and communicating commands to the host system based on the Device Specific Instructions accessed from the library.

The machine readable medium having the Device Independent Instructions preferably comprises a controller-independent storage medium (CISM) capable of storing computer-executable instructions, and the controller preferably includes an interface for communicating with the CISM and reading the machine executable instructions therefrom. The CISM may comprise, for example, a removable memory cartridge, a memory disk, a read only memory (ROM) device, an erasable programmable read only memory (EPROM) device, any read only or read write memory device, an EEPROM or FLASH ROM device, an I2C standard device on a serial chip, or any magnetic or optical media memory storage device. Common examples of a CISM include a secure digital disk card, a multimedia card, and a memory stick. The CISM further may include, for example, a floppy disk, an optical disk, and a USB storage device.

In this aspect of the invention, the UI further comprises a peripheral user interface (PUI) that is separate from, but communicates with, the controller. The PUI further may include the CISM, having thereon the computer-readable medium for storing the Device Independent Instructions.

Moreover, in this aspect of the invention, the PUI itself may include two members that removably couple together, including a communications component and a removable user interface (subRUI) that couples therewith. In such embodiments, the subRUI preferably includes the user inputs and the communications component transmits, for each user input that is actuated, an indication of actuation thereof to the controller. Such embodiments permit different subRUIs to be utilized with the same communications component. Moreover, the subRUI preferably includes the CISM, in which case the communications component transmits to the controller the Device Independent Instructions from the CISM for reading and interpreting thereof by the controller's processor. The communications component also may transmit any other applicable computer-executable instructions stored thereon for reading by the controller. Finally, it should further be noted that the subRUIs also may serve as RUIs for coupling directly with controllers, thereby providing yet further flexibility in the overall system of the present invention. That is, a user interface removably coupled to a controller as a RUI can be alternately removably coupled to a communications component of a PUI as a subRUI.

In commercial embodiments of this aspect, each PUI and CISM are packaged with the media content for which they are specifically developed to define a discrete media package, and the controller is sold separately and works with any such media package. Alternatively, if the PUI is provided in the form of two components that couple together, then the communications component thereof may be sold separately or with the controller, and the subRUI and CISM are packaged with the media content for which they are specifically developed.

### “GUI” Aspect of the Invention

In an aspect of the present invention, an apparatus for controlling a media event in a host system includes a controller and a user interface (UI) having user inputs. The apparatus further includes a machine readable medium having machine executable instructions specific to media content but not specific to any particular media device (“Device Independent Instructions”). Within this apparatus, the controller includes a processor, a program executed by the processor that interprets the Device Independent Instructions, and a library of software instructions accessible to the program for communicating by the controller to the host system, in a protocol of the host system, media device commands relating to the media event (“Device Specific Instructions”). The program, vis-à-vis the processor, in response to actuation of a user input of the UI, performs the steps of reading and/or interpreting Device Independent Instructions, accessing the Device Specific Instructions in the library based on the Device Independent Instructions read and/or interpreted, and communicating commands to the host system based on the Device Specific Instructions accessed from the library.

The machine readable medium having the Device Independent Instructions preferably comprises a controller-independent storage medium (CISM) capable of storing computer-executable instructions, and the controller preferably includes an interface for communicating with the CISM and reading the machine executable instructions therefrom. The CISM may comprise, for example, a removable memory cartridge, a memory disk, a read only memory (ROM) device, an erasable programmable read only memory (EPROM) device, any read only or read write memory device, an EEPROM or FLASH ROM device, an I2C standard device on a serial chip, or any magnetic or optical media memory storage device. Common examples of a CISM include a secure digital disk card, a multimedia card, and a memory stick. The CISM further may include, for example, a floppy disk, an optical disk, and a USB storage device.

In this aspect of the invention, the UI further comprises a graphical user interface (GUI) that is displayed on a screen and includes a plurality of user inputs for actuation thereof. Preferably, the controller includes the screen for display of the GUI, in which case the controller's processor preferably executes machine executable instructions for providing the GUI, and the CISM preferably includes the machine executable instructions for providing the GUI.

In commercial embodiments of this aspect, each CISM is packaged with media content for which it is specifically developed to define a discrete media package, and the controller, which preferably includes the display, is sold separately and works with any such media package.

In an alternative of this aspect of the present invention, a peripheral user interface (PUI) includes the screen, in which case a processor in the PUI preferably executes machine executable instructions for providing the GUI. (The PUI generally is described above in connection with another aspect of the present invention.) If the GUI is provided utilizing a screen of the PUI, then the PUI includes the machine readable medium having the machine executable instructions for providing the GUI or, alternatively, the PUI itself includes an interface for receiving a CISM that contains the machine readable medium having the machine executable instructions for providing the GUI. In embodiments of the PUI that comprise two components that couple together, the communications component preferably includes the screen, and the second component includes a CISM including the machine readable medium having the machine executable instructions for providing the GUI.

### “Ccontroller with Concitional Progranning Language” Aspect of the Invention

In another aspect of the present invention, an apparatus for controlling a media event in a host system includes a controller having a processor and a conditional programming language operating system, whereby the processor executes software containing conditional statements of logic (e.g., “if . . . then” instructions) for determining one or more appropriate commands to send to the host system in response to actuation of one or more user inputs. Preferably, software is written specifically for media content that is the subject of a media event in the host system and is stored in a controller-independent storage medium (CISM) that is provided in conjunction with the media content. Moreover, the controller preferably includes an interface for receiving the CISM and reading the software therefrom. The CISM may comprise, for example, a removable memory cartridge, a memory disk, a read only memory (ROM) device, an erasable programmable read only memory (EPROM) device, any read only or read write memory device, an EEPROM or FLASH ROM device, an I2C standard device on a serial chip, or any magnetic or optical media memory storage device. Common examples of a CISM include a secure digital disk card, a multimedia card, and a memory stick. The CISM further may include, for example, a floppy disk, an optical disk, and a USB storage device.

### “Accompanying Media Content” Aspect of the Invention

In yet another aspect of the present invention, additional media content is provided that accompanies and is presented by the apparatus for controlling the media event. The additional media content may represent audio and/or visual prompts, responses, answers, instructions, questions, scoring, or indications of progress. This additional media content preferably accompanies the Device Independent Instructions of the CISM. In some preferred embodiments the additional media content is specific to the media content selection to which the Device Independent Instructions are specific. In other embodiments, the additional media content is not specific to a particular media content selection. In accordance with this aspect of the present invention, a media presentation component is included in the apparatus for presenting this additional media content. This media presentation component of the apparatus may comprise a speaker and/or display screen of the controller for presenting this additional media content, or a speaker and/or display screen of the user interface (UI) if the UI is separate from the controller. If the UI comprises a GUI of the controller, then this additional media content may be presented on the GUI display of the controller as well as through a speaker of the controller in conjunction therewith.

These, and other aspects of the invention, as well as features thereof, will be more readily understood upon consideration of the attached drawings and of the following detailed description of certain preferred embodiments. Moreover, it should be understood that one or more aspects of the present invention may be combined together to form additional aspects of the present invention.

### “Controller and Removable User Interface (RUI) for Media Event and Additional Media Content 38 Aspects of the Invention

In an aspect of the present invention, an apparatus for controlling a media event in a host system includes a removable user interface (RUI), a user input, a controller to which the RUI is removably attached, a machine readable medium having device dependent instructions, and a controller-independent storage medium (CISM) having device independent instructions. Optionally, additional media content is presented through the controller to accompany the media event of the host system.

In commercial embodiments of this aspect, the RUI comprises a multi-page book having graphical indicia for guiding a user in selecting a particular user input. Furthermore, in such embodiments, each RUI and CISM are packaged with the media content for which they are specifically developed to define a discrete media package, and the controller is sold separately and works with any such media package.

### BRIEF DESCRIPTION OF THE DRAWINGS

Further aspects, features, and benefits of the present invention will be apparent from a detailed description of certain preferred embodiments thereof taken in conjunction with the drawings, wherein similar elements are referred to with similar reference numbers.

FIG. 1 is an overview of a preferred embodiment of one or more aspects of the present invention having a media device for presenting media presentation.

FIG. 2 is a perspective view of a preferred embodiment of an apparatus of one or more aspects of the present invention for controlling media presentation, which figure illustrates the combination of a removable user interface (RUI) with a controller in forming the apparatus.

FIG. 3 is a perspective view of three media packages in accordance with a preferred embodiment of one or more aspects of the present invention, each media package including a RUI and a DVD pair, wherein the media content of the DVD of a respective pair corresponds to the RUI of the pair.

FIG. 4 is another media package in accordance with a preferred embodiment of one or more aspects of the present invention.

FIG. 5 is another media package in accordance with a preferred embodiment of one or more aspects of the present invention, wherein the media content comprises home videos taken with a digital recorded that is saved on the DVD of the media package.

FIG. 6 is a perspective view of another preferred embodiment of a RUI and controller of one or more aspects of the present invention for controlling media presentation.

FIG. 7 is a perspective view of another preferred embodiment of a RUI and controller of the present invention for controlling media presentation.

FIG. 8 is a plan view of a preferred embodiment of a RUI of one or more aspects of the present invention for combining with the controller of FIG. 9.

FIG. 9 is a plan view of a preferred embodiment of a controller of one or more aspects of the present invention for combining with the RUI of FIG. 8, which controller includes a switch matrix.

FIG. 10 is a plan view of a preferred embodiment of a RUI of one or more aspects of the present invention for combining with the controller of FIG. 11, which RUI includes a switch matrix.

FIG. 11 is a plan view of a preferred embodiment of a controller of one or more aspects of the present invention for combining with the RUI of FIG. 10.

FIG. 12 is a view of a computer screen representing an exemplary script in accordance with a preferred embodiment of one or more aspects of the present invention.

FIG. 13 is a view of a computer screen representing an exemplary script in accordance with a preferred embodiment of one or more aspects of the present invention.

FIG. 14 is a view of a computer screen representing an exemplary script in accordance with a preferred embodiment of one or more aspects of the present invention.

FIG. 15 is a view of a computer screen representing an exemplary script in accordance with a preferred embodiment of one or more aspects of the present invention.

FIG. 16 is a view of a computer screen representing machine-executable instructions of a library of a controller in accordance with a preferred embodiment of one or more aspects of the present invention, the instructions being specific to a Sony DVD player.

FIG. 17 is a view of a computer screen representing an exemplary script in accordance with a preferred embodiment of one or more aspects of the present invention.

FIG. 18 illustrates operation of the Interpreter in a preferred embodiment of one or more aspects of the present invention, and in accordance with the exemplary script of FIG. 17.

FIG. 19 illustrates a controller, RUI, and CISM in accordance with one or more aspects of the present invention.

FIG. 20 illustrates a controller, GUI, and CISM in accordance with one or more aspects of the present invention, wherein the controller includes the GUI display and the CISM contacts the controller for communication there between.

FIG. 21 illustrates a controller and RUI in accordance with one or more aspects of the present invention, wherein the RUI includes the CISM and a GUI display.

FIG. 22 illustrates a controller and PUI in accordance with one or more aspects of the present invention, wherein the PUI includes a communications component having a GUI display and a second component comprising a CISM including the machine readable medium having the machine executable instructions for providing the GUI.

FIG. 23 illustrates a controller and PUI in accordance with one or more aspects of the present invention, wherein the PUI includes a communications component and the second component comprises a subRUI including the CISM.

FIG. 24 illustrates a controller, GUI, and CISM in accordance with one or more aspects of the present invention, wherein the controller includes the GUI display, and wherein the controller comprises a PDA and the CISM comprises a memory card.

FIG. 25 illustrates a media package in accordance with one or more aspects of the present invention, wherein the media package includes media content and a CISM comprising a memory card having computer executable instructions that are specific to the media content.

FIG. 26 illustrates a controller, GUI, and CISM in accordance with one or more aspects of the present invention, wherein the controller includes the GUI display, and wherein the controller comprises a PDA and the CISM comprises network attached storage from which software stored on the CISM is downloaded/read by the PDA.

FIGS. 27-28 illustrate an exemplary embodiment of one or more aspects of the present invention in which an apparatus for controlling a media event is utilized in conjunction with a DVD player and a television.

FIG. 29 illustrates a controller, RUI, and CISM in accordance with one or more aspects of the present invention, wherein the CISM further includes accompanying media content for presentation through a speaker of the controller.

FIG. 30 illustrates a controller, GUI, and CISM in accordance with one or more aspects of the present invention, wherein the controller includes the GUI display, and wherein the controller comprises a PDA and the CISM comprises a memory card, and further illustrates a user-defined script.

FIG. 31 illustrates an exemplary commercial embodiment of the preferred embodiment of FIG. 24.

FIG. 32 illustrates an exemplary commercial embodiment of the preferred embodiment of FIG. 26.

FIG. 33 illustrates a controller, user input, RUI, and CISM in accordance with one or more aspects of the present invention.

FIGS. 34A-34C illustrate exemplary commercial embodiments of a controller and user input of FIG. 33.

FIG. 34D illustrates an exemplary commercial embodiment of a CISM for use in conjunction with the embodiments of FIGS. 34A-34C.

FIG. 35 illustrates exemplary commercial embodiments of a RUI in use in conjunction with the embodiments of FIGS. 34A-34D.

FIG. 36 illustrates a media package in accordance with one or more aspects of the present invention.

FIG. 37 illustrates the presentation of a media event in accordance with one or more aspects of the present invention.

FIG. 38 illustrates a controller, RUI, and CISM in accordance with one or more aspects of the present invention.

FIG. 39 illustrates a controller, a RUI having a user input, and a CISM in accordance with one or more aspects of the present invention.

FIG. 40 illustrates a particular commercial embodiment of the controller of FIG. 38.

### DISCLOSURE OF INVENTION

As a preliminary matter, it will readily be understood by those persons skilled in the art that the present invention is susceptible of broad utility and application in view of the following detailed description of preferred embodiments of the present invention. Many devices, methods, and adaptations of the embodiments other than those herein described, as well as many variations, modifications, and equivalent arrangements, will be apparent from or reasonably suggested by the following detailed description without departing from the substance or scope of the present invention. Accordingly, while the present invention is described herein in detail in relation to preferred embodiments, it is to be understood that this disclosure is illustrative and exemplary and is made merely for purposes of providing a full and enabling disclosure of the present invention. The detailed description set forth herein is not intended, nor is to be construed, to limit the general breadth of the present invention or otherwise to exclude any such other embodiments, adaptations, variations, modifications and equivalent arrangements, the present invention being limited only by the claims appended in an issued patent therefor, and the equivalents thereof.

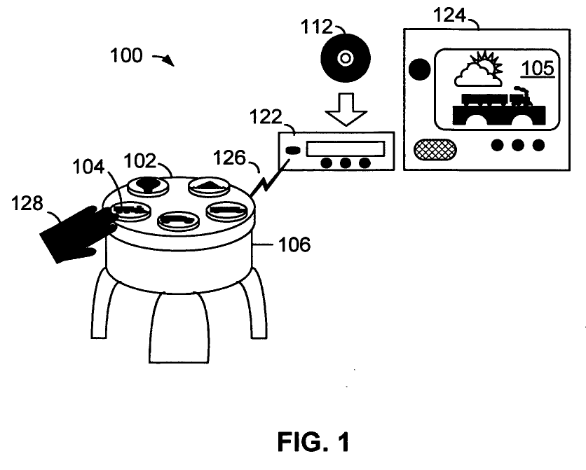

With reference to FIG. 1, a preferred embodiment 100 of a system of one or more aspects of the present invention is illustrated. This preferred embodiment 100 includes a multimedia system having a DVD player 122 for reading DVD 112 and associated video monitor or television 124 for displaying on screen 105 media content read from DVD 112. The DVD 112 in this preferred embodiment is an educational video for a child that pertains to different methods of transportations, including transportation by hot air balloons, sail boats, trains, trucks, and buses. The DVD player 122 is a conventional DVD player having an infrared receiver for receiving commands controlling presentation (e.g., display on screen 105) of the media content of the DVD 112. Conventionally, these commands are issued from a remote control device that accompanied the DVD player when it was purchased, or from a “universal” remote control device that was purchased separately and that includes the ability to send commands for various different DVD players including DVD player 122.

The preferred embodiment 100 of FIG. 1 also includes an apparatus for controlling the presentation of the media content, but the apparatus is not one of these conventional remote control devices. Instead, in this preferred embodiment the apparatus for controlling the presentation of the media content is a child's activity table for actual control of the media content by the child. In this regard, the activity table comprises a platform or table like structure comprising a base structure 106 having any suitable number of legs or supports (which may or may not be detachable), and an upper component comprising an overlay 102. The overlay 102 includes a plurality of user inputs comprising large buttons 104, and the activity table 106 includes the ability to issue commands wirelessly via signals 126 to the DVD player 122 in response to the pushing of the buttons by hand.

In particular, the pushing of a button (i.e., actuation of a user input) results in the DVD player 122 displaying a particular educational segment on screen 105. Moreover, in this preferred embodiment 100, the button includes graphical indicia pertaining to the media content that is displayed as a result of pushing the button. Thus, the pushing by hand 128 of the button including indicia of a train results in an educational video segment being displayed pertaining to trains. In other words, pressing a button lets a child trigger presentation of media content associated with the subject matter that is indicated by the button. This type of interaction between a user and media presentation is most suitable for children within the age groups of one to three, teaching a child basic motor skills and empowering the child, and is preferably used to instruct a child about basic sets of abstract concepts regarding, for example, colors, shapes, letters, numbers, animals, and instruments.

It should also be noted that greater interactive content media also can be utilized. In this regard, the media content presentation may include a question and answer format, wherein the media content displayed directly poses a question that can be answered by pushing a particular button. As an example, a segment of a video may state, “Click on the animal that eats bananas,” and wherein the child then clicks on the button depicting a monkey and triggers the positive response “You're right! A monkey eats bananas!” or, alternatively, clicks on a button depicting another animal and triggers the response “Sorry, Please try again!” Alternatively, the media content presentation may include a “choose your own adventure” format, wherein the media content narrative pauses at key points in a storyline in order for the child to determine the future direction of the story. As an example, a segment of the video may state, “Should you go take the road going North or the road going South?” and wherein, if the child then clicks on the button indicating “North” the story resumes with that choice as its basis and if the child then clicks on the button indicating “South” the story resumes with that alternative choice as its basis.

As will be appreciated, overlay 102 is not generic to DVD 112 because the overlay 102 provides illustratively labeled button 104 that are correlated to different portions of the media content of DVD 112.

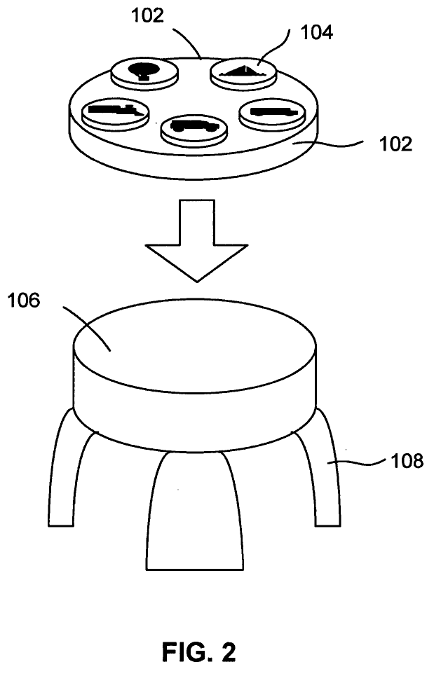

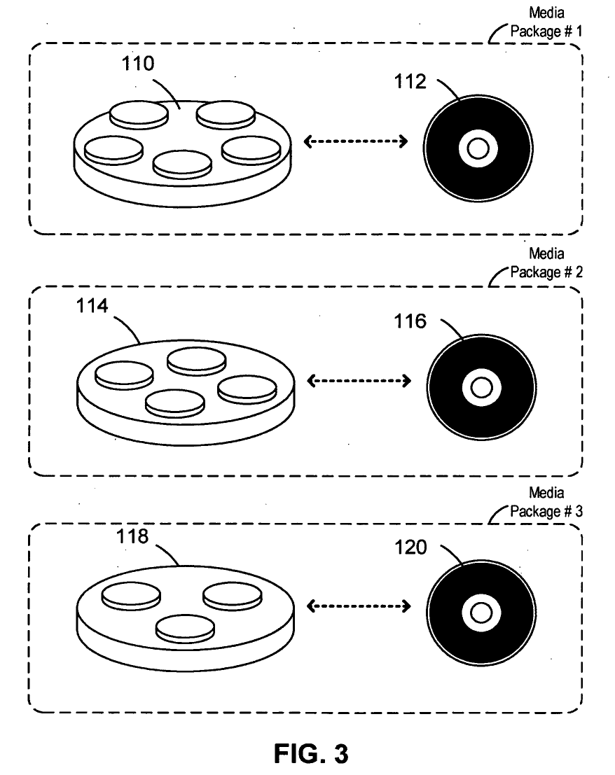

In accordance with one or more aspects of the present invention, the overlay 102 of FIG. 1 is removably attachable to the base structure 106 as illustrated in FIG. 2. Accordingly, the base structure 106 may accept any one of various overlays corresponding to different DVDs that may be used in the multimedia system. Thus, for example, with reference to FIG. 3, the three different media packages may be used with base structure 106. Indeed, each media package comprises a DVD and an overlay corresponding to that DVD's media content. DVDs 112, 116, 120 thus respectively correspond to overlays 110, 114, 118, and each of the overlays includes a different number of buttons with different indicia (not shown) thereon.

With regard to one or more aspects of the present invention, the multimedia system of FIG. 1 is an example of a host system, the base structure 106 is an example of a controller, and the overlay is an example of a removable user interface (RUI). Additionally, the buttons of the overlay 102 are an exemplary embodiment of user inputs.

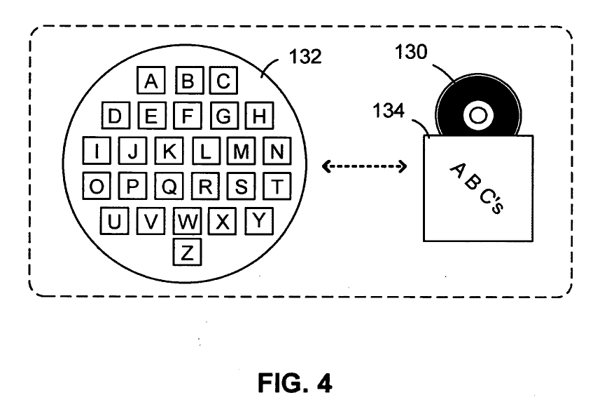

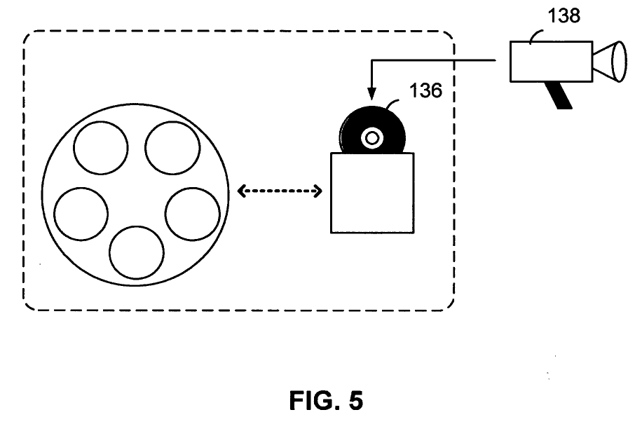

A preferred media package is illustrated in FIG. 4, and includes a CD 130 having data for songs drawn to letters of the alphabet. The corresponding overlay 132 includes an array of buttons having these letters of the alphabetic illustrated thereon for effecting user selection of songs on the CD 130. A sleeve 134 is useful to store, protect, and identify the CD 130 that is correlated with the overlay 132. Another preferred media package is illustrated in FIG. 5, wherein a DVD 136 has been used with a video recorder 138 to create videos. In accordance with the present invention, user actuation of a button of the overlay initiates playback of a particular video corresponding to indicia (not shown) of that button.

Other preferred embodiments of media packages (not shown) include a media package for use or study of geographic content regarding the United States or geometric shapes. In the former example, the overlay is arranged as a map with the buttons shaped and arranged as states. The pushing of a state shaped button then would result in presentation of educational information on that state, which information is stored on a DVD corresponding to the overlay. In the latter example, the overlay includes buttons of various geometric shapes, such as a circle, triangle, rectangle, and square. The pushing of a geometrically shaped button then would result in presentation of educational information on that particular geometric shape of the button, which information is stored on a DVD corresponding to the overlay.

In should be noted that, in the preferred embodiments of FIGS. 4 and 5, the overlays are examples of RUIs, and the CD and DVD are examples of machine readable media having media content. Additionally, the correspondence between a RUI and machine readable medium having the media content is represented in FIG. 3 through 5 by the dashed arrows pointing therebetween.

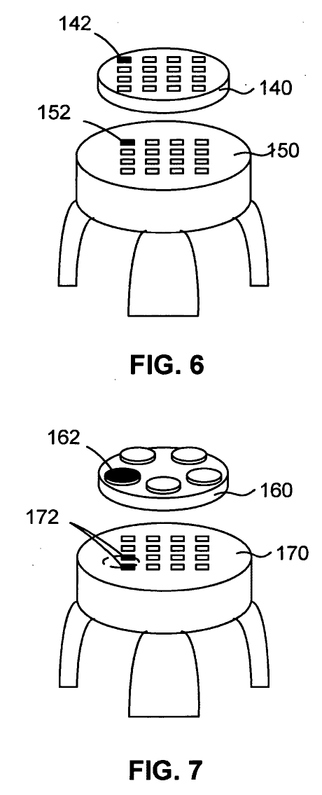

With respect to the attachment of an overlay to a controller, FIG. 6 illustrates an overlay 140 that is attachable to base structure 150, wherein an array of user inputs (represented by rectangles) corresponds identically to an electrical switch matrix of the base structure 150. Thus, input 142 corresponds with switch 152, whereby user actuation of input 142 results in a signal generated by switch 152. A similar arrangement is illustrated in FIG. 7; however, in FIG. 7 there are fewer user inputs than switches. Thus, for example, actuation of input 162 results in a signal being generated by switches 172. In these illustrated arrangements, each of the particular inputs 142, 162 comprises a mechanical component that, when the respective overlay 140, 160 is coupled to the base structure 150, 170, is positioned directly above the respective switches 151, 172.

It should be understood that any desired or suitable n to m correlation of any number (n) inputs to any number (m) of controller switches is within the scope of the present invention. Furthermore, though the figures illustrate for convenience spatial alignments of user inputs to correlated controller switches, it should be understood that other alignments or associations facilitated by cantilevers, pads, moving parts, or electrical contacts correlating any one, any number, or any area of inputs to any one, any number, or any area of controller switches are within the scope of the present system.

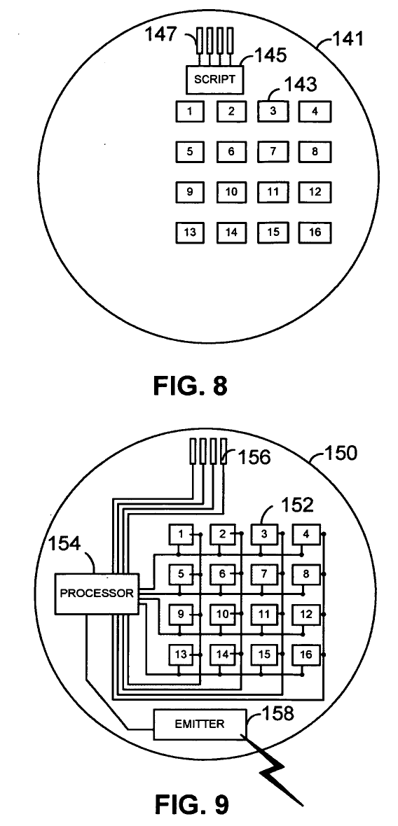

With reference now to FIGS. 8 and 9, an exemplary plan diagram of a RUI and controller is shown. The RUI 141 comprises a thin membrane or sheet having inputs 143 that comprise designated rectangular areas for guiding the application of pressure by a user's finger. Furthermore, the inputs 143 comprise a 4×4 array. When the RUI is attached to the controller, each of the inputs 143 overlie and align with rectangular switches 152 of a switch matrix of the controller 150. Thus, when the RUI 141 is attached to the controller 150, a user applying pressure to an input 143 causes a particular underlying switch 152 to provide an electronic signal.

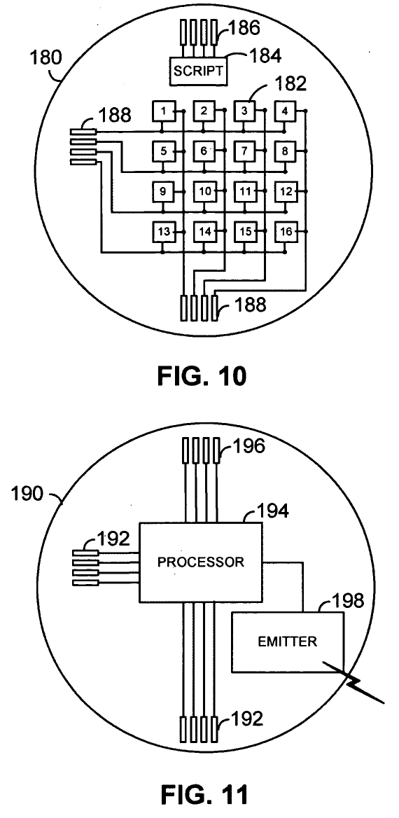

A similar, but alternative exemplary plan diagram of a RUI and controller is shown, respectively, in FIGS. 10 and 11. In this instance, a switch matrix is included in the RUI 180 rather than in the controller 190. Indeed, the switches 182 of the switch matrix of the RUI 180 comprise, themselves, the user inputs of the present invention. When the RUI 180 is attached to the controller 190, a user applying pressure to a particular switch 182 of the RUI 180 causes an electronic signal to be provided.

Whether an electronic signal is provided by a switch in the controller 150 of FIG. 9, or by a switch in the RUI 180 of FIG. 10, a processor in the controller, which processor preferably comprises a microprocessor, receives the signal provided by the switch when the RUI is attached to the controller. In this regard, a signal provided by a switch 143 in controller 150 is communicated directly from the switch matrix to processor 154, and a signal provided by a switch 182 in the RUI 180 is communicated from the switch matrix of the RUI 180 to processor 194 in the controller 190 through electrical contacts 188 of the RUI 180 that abut electrical contacts 192 of the controller 190. A power source, such as a battery (not shown), preferably is included in the controller for generating electrical signals from switches.

Upon receiving an electronic signal, ultimately in response to actuation of a user input of a RUI, the processor (in accordance with a program that it runs) responds appropriately such as, for example, by causing an emitter, which is also included in the controller, to transmit an appropriate command to a media device. The emitter can be any wireless transmission device, for example, a radio frequency (RF) transmitter, an infrared (IR) emitter, an IRDA device, or a Bluetooth device. Alternatively or in conjunction with a wireless device, the emitter can comprise any conducting wire or fiber optic signal generator. The emitter sends signals to control external devices such as DVD players, CD players, computers, and televisions, just to name a few. The emitter can be coupled to one or more media devices through a parallel port connection, a serial port connection, or a USB port connection. Additionally, when the emitter comprises an IR emitter, the emitter preferably is a multiple angled emitter, which helps insure that transmissions are received despite potential line of sight obstacles.

As will be appreciated, the appropriate response by the processor to an electronic signal will be dependent upon the media package, i.e., the media content being presented and the RUI being utilized. To illustrate this “dependency” point, take for example the base structure 150 of FIG. 6 and base structure 170 of FIG. 7. Either may accommodate any number of different overlays having similar or varying input arrangements such as, for example, the overlay 140 of FIG. 6 and the overlay 160 of FIG. 7. In this regard, base structure 150 is interchangeable with base structure 160, i.e., each base structure 150, 160 may receive overlays 140 and 160. Moreover, the media content associated with overlay 140 may provide for workplace training of employees including, for example, sixteen training lessons to which the sixteen inputs of the overlay 140 correspond. In contrast, the media content associated with overlay 160 may comprise a five act play to which the five inputs of the overlay 160 correspond. In order for the processor of the base structure to take the appropriate response upon actuation of a user input of one of the overlays, the processor must be instructed how to respond as a function of the particular overlay to which it is attached. A signal received from one or more particular switches when a user input 142 of overlay 140 is actuated most likely should not result in the same response when a signal is received from the same switches when a user input 172 of overlay 160 is actuated. A signal that is received from a switch of the controller when overlay 140 is attached may result in the eighth training lesson being shown, whereas a signal that is received from the same switch of the controller when overlay 160 is attached may result in viewing of the third act of the play.

In order that the processor of the controller is properly instructed how to react when a signal is received, each RUI contains machine executable instructions stored in a machine readable medium, such as software stored in memory of the RUI. This memory represents a controller-independent storage medium (CISM). In preferred embodiments of one or more aspects of the present invention, the software comprises a script that is interpreted by the processor by running a program that is a script engine or script interpreter (hereinafter referred to as “Interpreter”). Furthermore, the script stored in the CISM preferably is at least partially compiled. The script essentially comprises control or navigational rules by which the Interpreter determines an appropriate response to receipt of a signal upon actuation of a user input. By providing script that is specific to media content associated with a particular overlay, overlays are able to couple to, and function with, similar or identical controllers; the scripts of the overlays provide the specific control or navigational rules appropriate to the media content to which the overlays correspond; in essence, the script provides the logic by which the Interpreter operates.

The script is read by the Interpreter through electrical contacts between the RUI and the controller. Again, with reference to FIGS. 8 through 11, script in overlay 141 resides in CISM—or script element 145—and script in overlay 180 resides in CISM—or script element—184. Electrical contacts 147 in RUI 141 and electrical contacts 186 in RUI 180 abut, respectively, electrical contacts 156 in controller 150 and electrical contacts 196 in controller 190 and respectively connect the processors in controllers 150, 190 in communication with script elements 145, 184. Furthermore, the script is read when the overlay is connected to the controller, or alternatively, on a case by case basis as a signal is received by the processor. The script storage element can include, for example and not by way of limitation, a magnetic strip, a removable memory cartridge, a memory disk, a read only memory (ROM) device, an erasable programmable read only memory (EPROM) device, any read only or read write memory device, an EEPROM or FLASH ROM device, an I2C standard device on a serial chip, or any magnetic or optical media memory storage device.

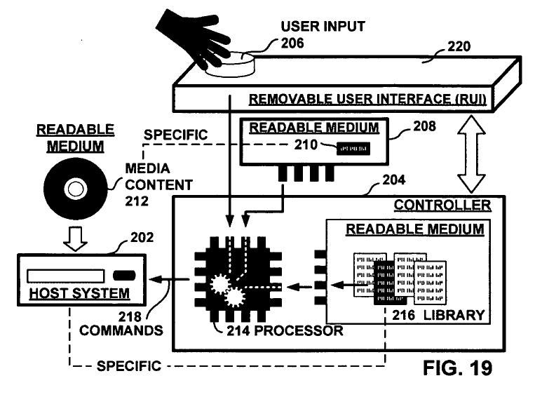

It will be appreciated that the script of a particular overlay, while dependent upon the media content, is not dependent upon, and thus is independent of, the particular host system, e.g., the particular DVD player that is used for presentation of the media content. Instead, the controller is dependent upon the particular host system in that the controller includes the particular communication protocol of the host system so that appropriate commands controlling the media presentation may be communicated to the host system. Moreover, the controller preferably includes a library of communication protocols or codes for different host systems, whereby the same controller can be used with different host systems similar to the multiple use capability of “universal” remotes with various electronic devices of different manufacturers. Of course, the particular media devices that are used in a particular environment will need to be identified to the controller for appropriate identification by the controller of the device specific commands from which to select in its library. The controller also preferably includes upgrade capabilities, whereby the library can be updated over time with additional communication protocols to ensure compatibility with future host systems and components thereof. Each protocol enables the Interpreter to communicate commands to the host system via the emitter for control of the media presentation. By making the user interface (UI) independent of the host system but dependent upon the media content, making the controller independent of the media package but dependent upon the host system, and by making UIs interoperable with different controllers, the present invention enjoys great flexibility and utility. Indeed, a single controller can serve a wide variety of UIs, and a single controller can be utilized with a wide variety of host systems. This relationship is further illustrated, for example, in FIG. 19.

In an aspect of the present invention, as illustrated in FIG. 19, an apparatus for controlling a media event in a host system 202 includes a controller 204 and a user interface (UI) having user inputs 206. The apparatus further includes a machine readable medium 208 having machine executable instructions 210 specific to media content 212 but not specific to any particular media device (“Device Independent Instructions”). Within this apparatus, the controller includes a processor 214, a program executed by the processor that interprets the Device Independent Instructions, and a library 216 of software instructions accessible to the program for communicating by the controller to the host system, in a protocol of the host system, media device commands 218 relating to the media event (“Device Specific Instructions”). The program, vis-à-vis the processor, in response to actuation of a user input 206 of the UI, performs the steps of reading and/or interpreting Device Independent Instructions, accessing the Device Specific Instructions in the library based on the Device Independent Instructions read and/or interpreted, and communicating commands to the host system based on the Device Specific Instructions accessed from the library. The UI in this aspect of the invention may further comprise a removable user interface (RUI) that couples directly with the controller.

The machine readable medium 208 having the Device Independent Instructions 210 preferably comprises a controller-independent storage medium (CISM) capable of storing computer-executable instructions, and the controller 204 preferably includes an interface for communicating with the CISM and reading the machine executable instructions therefrom.

With additional regard to the library of communication protocols of the controller, the Interpreter may access and read command codes of a particular host system as part of an initialization process when the overlay is coupled to the controller, or the Interpreter may read command codes periodically or upon actuation of a user input. Upon receipt of a signal, the Interpreter first refers to the script for the appropriate response and, then, refers to the particular protocol and command or commands of the host system, as reflected in the protocol for that host system, in order to achieve the appropriate response as identified with reference to the script. The Interpreter then causes the appropriate command or commands to be transmitted to the host system by the emitter. For example, an appropriate response to a signal that is received by the Interpreter may be, pursuant to the current script, to access a particular title and chapter, begin play, and then pause playback until an another signal is received as a result of a subsequent user actuation of a RUI input. To accomplish this response, the Interpreter determines the appropriate commands to communicate to the host system.

With additional regard to the Interpreter, the script language preferably comprises a complete media programming language written in modular fashion that includes features of conditional branches; states maintained; and variable data created, read, and updated. The Interpreter also preferably is backwards compatible for interpreting script written for older versions of the Interpreter, thereby allowing the software language to evolve without requiring hardware upgrades in the field. The script language preferably contains high level verbs that allow users to easily control interactive media, and contains all of the normal programming constructs, such as conditional statements, loops, macros, parameters, variable data, data storage, etc.

Each script preferably is developed utilizing an application programming interface (API) which can be a simple scripting language based upon standard XML protocols. The script language also preferably utilizes standards based on widely accepted XML syntax to provide the mechanism for scriptable media interactivity. Robust conditional logic and an event driven model enable considerable flexibility in the adaptability of instructions, making complex forms of interactivity possible.

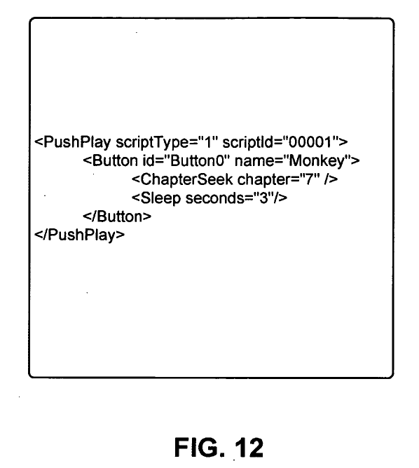

An exemplary script for an input comprising a button is shown in FIG. 12. In accordance with this simple example, when the Monkey Button is pressed, the presentation of the media content of Chapter 7 begins, which relates to monkeys.

With regard to further detail of the script structure, the syntax is XML elements and attributes. Commands (verbs) are XML elements. Parameters are XML attributes. Using this syntax, the script language is easily created or changed. Commands can be upgraded by modifying the parameters (attributes). New commands can be added, or dropped.

For example, if a command to issue the “Play” command to a DVD is desired, then the command that is utilized is <Play/>. If later the behavior of this command is to be changed, then parameters (attributes) could be added. Thus, the inclusion of a parameter “seconds” could be added. This parameter, if present, would issue the Play command for “n” seconds and then Pause, and the command would look like <Play seconds=“10”/>. Furthermore, such changes take place without modification of a compiler since they adhere to the XML syntax.

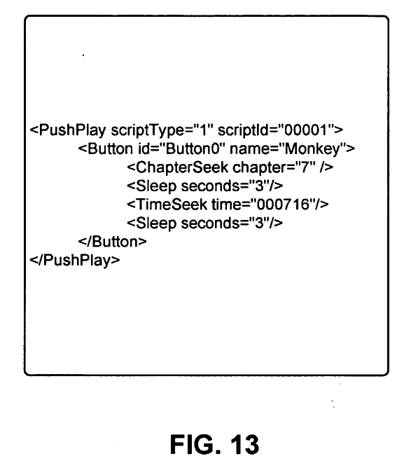

Another aspect of XML that is utilized in the script language is the concept of “child elements,” which provide many advantages. The primary use is to group commands to be executed when a particular user input (such as a button) is actuated. For example, a group of commands are issued when the “Monkey” button is pressed in accordance with the script of FIG. 13. This concept also is used for macros.

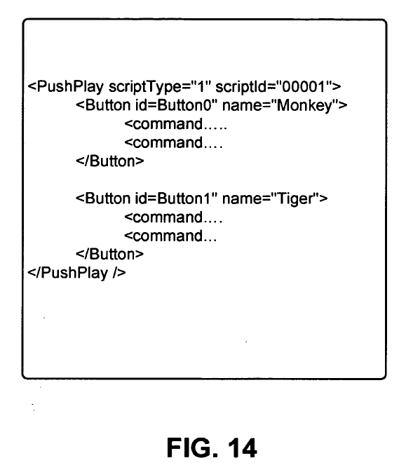

As will be apparent from the foregoing, a script in accordance with preferred embodiments of one or more aspects of the present invention includes a collection of media device independent commands for controlling media presentation, as illustrated in FIG. 14.

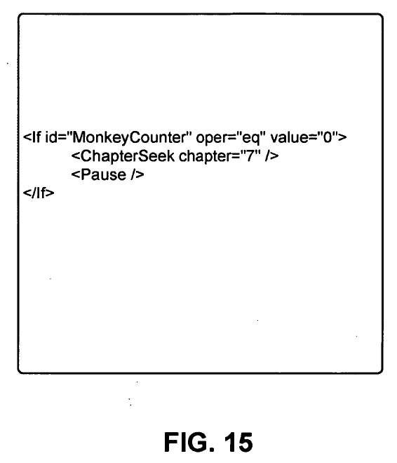

An example of a conditional statement in a script is shown in FIG. 15. Therein, all child elements (commands) are executed if the condition is true.

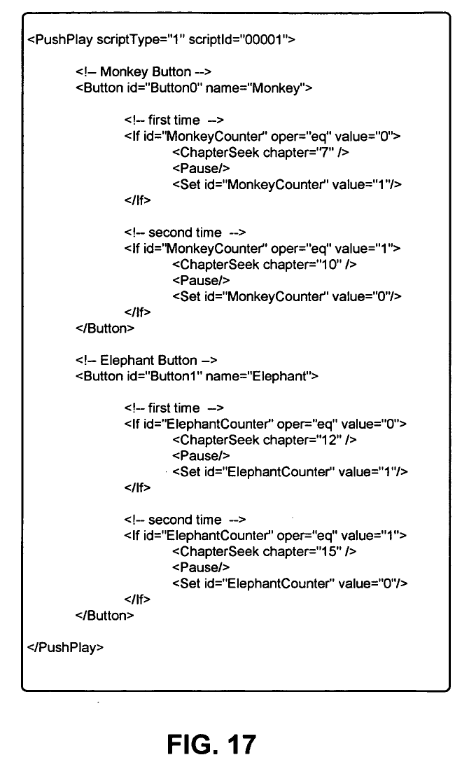

The exemplary script of FIG. 17 demonstrates a RUI having animal shaped user inputs comprising buttons. There are two buttons provided for, which include a Monkey button and an Elephant button. When the Monkey button is pressed, it displays the content in Chapter 7 of the DVD. When the button is pressed again it display the content in Chapter 10. When it is pressed again, it reverts back to Chapter 7. When the Elephant button is pressed, it first displays Chapter 12, and when it is pressed again, it then displays Chapter 15. This exemplary code demonstrates the robustness of the present invention in providing an appropriate response to actuation of a user input based on prior history of the user session during the presentation.

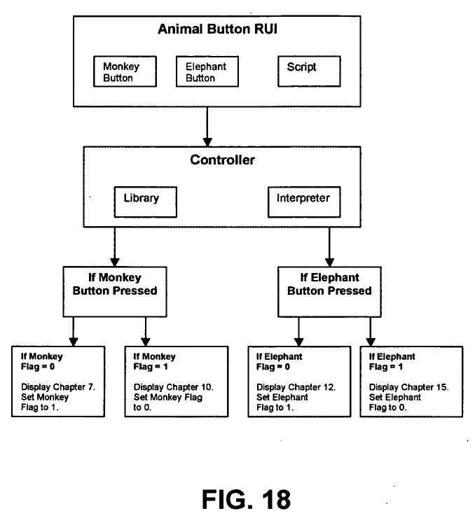

With reference to FIG. 18, the RUI represented therein contains, among other things, a monkey shaped button and an elephant shaped button and the script element contains the script of FIG. 17. This particular RUI, for example, is associated with an educational video DVD about animals. Additionally, the controller includes the Interpreter and the library by which appropriate signals are able to be sent for controlling display of the media content on the DVD. The media device displaying the media content, for example, is a Sony DVD player.

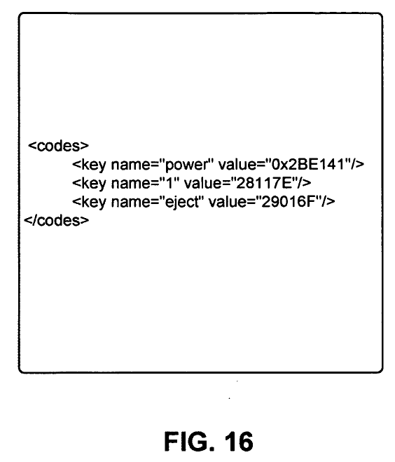

With reference to FIG. 16, machine-executable instructions of the library that are specific to the Sony DVD player are illustrated. These instructions are stored within the library of the controller and enable the controller to communicate, in an appropriate protocol of the Sony DVD player (e.g., via infrared transmission), the device-specific code for the command that is to be performed by the Sony DVD player. Examples of the “Power” command and “Eject” command are shown. Data associated with commands also can be communicated utilizing the library instructions (a command and associated data each generally being referred to herein as a command). An illustrated example of this in FIG. 16 is the instruction for communicating numeral “1” to the Sony DVD player.

In accordance with FIG. 18, when the monkey button is pressed, the Interpreter searches the Script to find the command to execute for this Button. Upon finding the appropriate command in the Script, the Interpreter checks the monkey flag in order to determine which Chapter to display. If the switch is 0, the Interpreter determines that Chapter 7 is to be displayed and, additionally, then sets the flag to 1. If, on the other hand, the flag is already 1, then the Interpreter determines that Chapter 10 is to be displayed and, additionally, sets the flag to 0. A similar method is utilized with respect to alternative actuation of the elephant button.

As demonstrated in FIG. 18, the effect of pressing the same button may be dynamic. The first time the button is pressed one chapter is displayed. On the second press, a different chapter is displayed. Also note that in the script of FIG. 17, no reference is found reflecting that the media device is a Sony DVD player; the script is independent of the media device. Specific codes for executing the commands in the script on the Sony DVD player are found in the library of the controller.

Scripts can be created with any available and suitable text editor. Additionally, scripts can be compiled into a machine independent format suitable for placing in script storage. Compiling a script can greatly reduce its size and allow its maintenance in machine independent format. A “drag and drop” visual editor can aid programming in the overlay software language and enable a producer with little programming skills to create interactivity instructions for a specific overlay. An integrated DVD player can allow editing, playback and testing from a single workstation. More technical users can be provided the option of editing using a more traditional development interface.

A programmer or developer adds commands to a “Table of Commands” in the Interpreter. The developer then provides the address of a software routine that will be called when the script so indicates by reference to a command of the Table of Commands.

For example, when the “Sleep” command is interpreted, the referenced program code performs the following, a) Fetch the “seconds” parameter, b) Fetch the “milliseconds” parameter, c) Delay program execution for the appropriate amount of time as specified by the parameters.

If it were desired that the command be changed to have parameters for minutes and seconds instead of seconds and milliseconds, then it would be extremely easy to change the program code to support the different parameters. Moreover, no changes in a compiler or the Interpreter would be required. Thus, for a command to be removed, it only need be deleted from the Command Table and the code thereof removed that would otherwise be called in execution of the command. Conversely, to add a command, an entry in the Command Table needs to be made with appropriate reference to the code for executing the command.

In accordance with preferred embodiments of one or more aspects of the present invention, the script language preferably includes the following commands that relate to DVD players: MENU (stops title playback and displays the top or root menu for the current title of the DVD); TITLE (stops title playback and displays the title menu); RESUME (returns to playback mode from menu mode at the same title position as when the menu was invoked); BACK (returns the display from a submenu to its parent menu); PLAY (causes the DVD to start playing, or resumes play of a paused item); STOP (stops the playing of the DVD); PAUSE (pauses the playing of the chapter); NEXTCHAPTER (seeks and plays the next chapter; will loop); PREVCHAPTER (seeks and plays the previous chapter. Will loop); TITLESEEK (seeks and plays the first chapter in the title; title number is 1 to 99); CHAPTERSEEK (seeks and plays the chapter in the current title; chapter number is 1 to 999); TIMESEEK (seeks to a specific time on the DVD; parameters include hour, minute, and second); FASTFORWARD (starts fast forwarding); FASTREVERSE (starts fast reversing); PUSHBUTTON (simulates a button press on a remote control device); and PUSHNUMBERS (simulates pressing the number buttons).

Basic commands that are found in all scripts regardless of the actual implementation of the present invention preferably include: PUSHPLAY (defines a new script; parameters include script type and id); BUTTON (defines commands that will be executed when signal for button is received); TRICKPLAY (defines a macro, whish is a collection of commands that will be executed multiple times; parameters can be passed that modify macro behavior); IF (Conditional command; will execute block of commands if condition is true); SET (sets value of a variable data item); @(FETCH) (returns value of a variable); INCREMENT (increments a variable with a range; when maximum limit is reached, will restart a minimum value); APPEND (appends a string value to a variable); BUTTONSON (enables PushPlay to react to button presses); BUTTONSOFF (disables PushPlay from reacting to button presses); SLEEP (sleeps for time period; awakens upon RUI input actuation); and SLEEPHARD (sleeps for time period; does not wakeup upon RUI input actuation).

Commands and parameters of a preferred embodiment implemented in computer software can be found in the file titled “PushPlayScriptingAPI.txt”, which is submitted herewith and is hereby incorporated herein by reference. An exemplary script facilitating understanding of the present invention also can be found therein.

In a feature of one or more aspects of the present invention, the Interpreter also monitors and records historical data regarding session use of a user interface (UI). This collected data then may be utilized to modify future sessions or provide feedback to users. Such data may include the number of times a particular user input is actuated, the performance level of a user in interacting with an interactive media presentation, or the number of “right” answers that are provided by a user in response to certain media content, such as an interactive educational video. Memory in the controller and or the overlay may be utilized in storing such monitored data. Instructions for monitoring and recording the data, if any, preferably are included in the script.

In another feature of one or more aspects of the present invention, the controller is a multi mode device and the interpreter maintains the state of the controller, whereby different responses may be provided as a function of the current state of the controller upon receipt of the same signal. For example, when the mode switch is set to position “1,” actuation of a specific user input may initiate the playing of chapter 10; however, when the mode switch is set to position “2,” actuation of the same user input may initiate the playing of the next chapter, or the playing of chapter 36, for example.

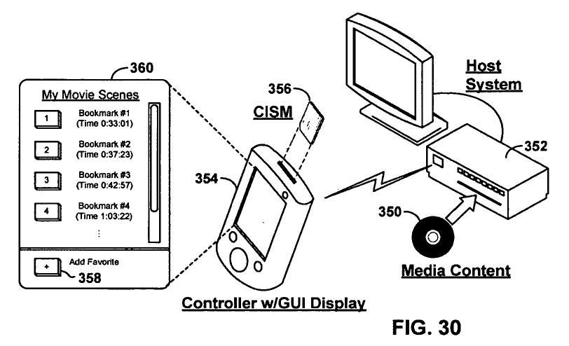

In yet another feature of one or more aspects of the present invention, users themselves are able to “write” scripts for their own personal use. In this regard, a program or one or more macros are provided that automate the script writing function, whereby users do not have to actually know any particular scripting language in order to create and customize scripts for their use and enjoyment in controlling media events. FIG. 30 illustrates an example of this, wherein a DVD 350 containing a movie is inserted into a DVD player 352 for viewing. A PDA 354 serves as the controller, and wirelessly communicates with the DVD player for controlling presentation of the movie. The PDA receives a SecureDigital (™) memory card 356 that serves as the CISM containing a script. The script includes macro software that enables a user to bookmark the movie as the user views the movie by simply actuating the “+” user input 358 for adding a favorite bookmark to the user's list. This list of favorites, including bookmark numbers 1-4 as shown, is stored on the CISM. Moreover, by simply selecting any of buttons 1-4 of this graphical user interface (GUI) 360 of the controller, presentation of the movie is initiated at the appropriate timestamp of the bookmark (which also is indicated in the GUI). It will be apparent that by selecting the “+” user input, the program providing the GUI generates scripting code for creation of the appropriate bookmark as well as code for initiating viewing of the movie at the timestamp of the bookmark. This code is stored in the CISM for use during future viewings of the movie on the DVD. Furthermore, it will be appreciated that, due to the benefits of one or more aspects of the present invention, the DVD player may be substituted with another DVD player of another manufacturer having a different communications protocol for control commands; however, the ability to continue to utilize the bookmarks and the PDA will be unaffected so long as the communication protocol of the new DVD player resides in the library of the PDA (or until the library is updated to include such communication protocol).

In view of the foregoing detailed description of preferred embodiments of one or more aspects of the present invention, it readily will be understood by those persons skilled in the art that these aspects of the present invention are susceptible of broad utility and application. While various aspects have been described in certain contexts, the aspects may be useful in other contexts as well. Many embodiments and adaptations of these aspects of the present invention other than preferred embodiments described herein, as well as many variations, modifications, and equivalent arrangements, will be apparent from or reasonably suggested by the foregoing description, without departing from the substance or scope of the present invention.

Furthermore, any sequence(s) and/or temporal order of steps of various processes described and claimed herein are those considered to be the best mode contemplated for carrying out these described aspects of the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions.

Accordingly, while one or more aspects of the present invention have been described herein in detail in relation to preferred embodiments, it is to be understood that this detailed description is only illustrative and exemplary of these aspects of the present invention and is made merely for purposes of providing a full and enabling disclosure of the invention. The foregoing disclosure is not intended, nor is to be construed to limit, the present invention or otherwise to exclude any such other embodiments, adaptations, variations, modifications and equivalent arrangements.

For example, with regard to the preferred embodiment 100 of FIG. 1, the apparatus for controlling the media presentation is disclosed as being a child's activity table. Alternatively the apparatus can be constructed as a laptop unit to be placed on or over the lap of a seated user and can be constructed as a tray like unit for coupling with, for example, a child's chair having rails for receiving a tray.

In addition thereto, the overlay 132 of FIG. 4, for example, has been illustrated with rectangular keys. However, any shape of the keys may be used in accordance with one or more aspects of the present invention and, in fact, the keys may be shaped in a manner that indicates the media content presented by user actuation of the keys. For instance, the keys of the overlay 132 of FIG. 4 may be shaped as alphabetic letters, with the shape of the keys comprising in this instance the aforementioned indicia of the user inputs. Indeed, the materials, shapes, and sizes of overlays are completely variable. An overlay can comprise a touch screen or a sheet of cardboard with imprinted buttons. User inputs may be spring loaded buttons that are, for example, plastic or rubberized. Exemplary user inputs include mechanical actuators that couple to electrical switches of a controller. Other examples include user inputs that are electrical switches that couple to conductive contacts of a controller.

Each RUI is specific to the medium content of a particular medium unit, with user input concepts that relate to its purpose and content, and look-and-feel branding based on the brand and/or content of the DVD. A RUI can have any size, shape, and form of user inputs that makes sense for its content and educational purpose. For example, the RUI and/or controller could resemble a book, wherein the turning of the pages of the book triggers a media event related to the content of the current page(s) of the book being viewed. The RUI also could take the form of a mini-piano, wherein certain notes or chords trigger particular video and/or audio presentations. More complex interactivity formats, like the “question-and-answer” format, could be used to teach and test specific notes and chords in learning to play the musical instrument. The RUI could further include a dance mat, wherein certain step combinations would trigger particular video and/or audio presentations. A RUI also could comprise a character or doll, wherein pressing of certain parts of the body would trigger media events for teaching about the body parts, etc. The RUI and/or the controller also could include a voice recognition component, wherein voice commands to trigger media events would be enabled.

Additionally, within the scope of the inventive system, there are various alternatives to storing scripts in a script element of a RUI for access by the Interpreter. Such alternatives include dynamically reading and accessing the script by the Interpreter, either wirelessly (IR, IRDA, radio) or wired (rs232, Ethernet, USB, etc.). This is especially convenient when the script has been compiled, making it easily portable to many different environments. Of course, the script that is accessed by the Interpreter would still need to be dependent upon the RUI that is used with the controller.

It will also be appreciated by those having ordinary skill in the art that the foregoing description of one or more aspects of the present invention encompasses not only presentation of media content, but control of other media events utilizing a controller and removable RUI. Thus, for instance, a command to record media content can be communicated to a host system in accordance with these aspects of the present invention with, for example, the UI being associated with the media content to be recorded.

Finally, while these aspects of the present invention have been described with regard to preferred embodiments directed to children toys and/or child education, the present invention is useful in a wide range of applications including educational tools, product demonstrations, healthcare applications, and entertainment purposes for people of all ages and interests.

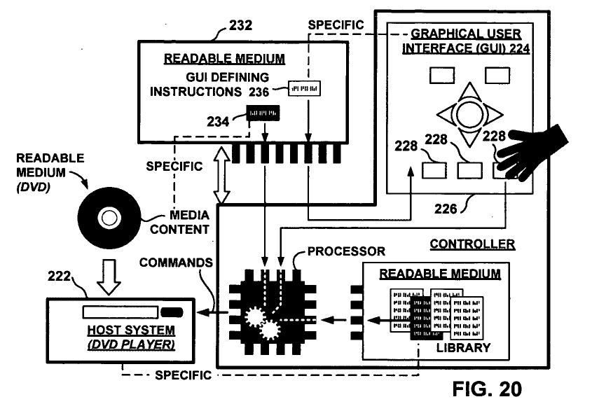

In addition to the foregoing detailed description of certain preferred embodiments of one or more aspects of the present invention, another preferred embodiment of one or more aspects of the present invention is illustrated in FIG. 20, wherein an apparatus for controlling a media event in a host system 222 includes, in lieu of a RUI, a graphical user interface (GUI) 224 that is displayed on a screen 226 and includes a plurality of user inputs 228 for actuation thereof. Furthermore, in this embodiment, the controller 230 includes the screen. The GUI display screen preferably is a touch sensitive screen that displays the user inputs and generates an input signal upon the touching of the area of the screen defining a user input.

Like the Device Independent Instructions, the user inputs of the GUI preferably are specific to the media content. In this regard, the user inputs of the GUI preferably appear in arrangements each specific to a particular media content selection. For example, the GUI also may include user inputs representing navigational functions that are related to the particular selection. In a particular commercial embodiment, the user inputs of the GUI comprises a pictorial representation of the alphabet, and the machine readable medium having the GUI defining instructions and the media control instructions comprises a cartridge that commercially accompanies a DVD having interactive educational content directed to alphabet lessons for children. In utilizing this commercial embodiment, a user places the learning DVD into a DVD player, engages the cartridge with the controller, and presses any particular alphabet letter represented on the GUI to enjoy particular content portions of the learning DVD regarding the particular letter.

The CISM comprises a removable storage medium 232 that removably couples to the controller 230, and includes machine executable instructions 234 that are specific to the media content (the “Media Control Instructions”) as well as machine executable instructions 236 for providing the GUI on the display screen (the “GUI Defining Instructions”). The GUI Defining Instructions 236 define the user inputs of the GUI that provide the user with virtual buttons for interactive viewing of the media content. The controller's processor reads these instructions for providing the GUI and for interpreting actuation of user inputs of the GUI and determining appropriate actions to take.

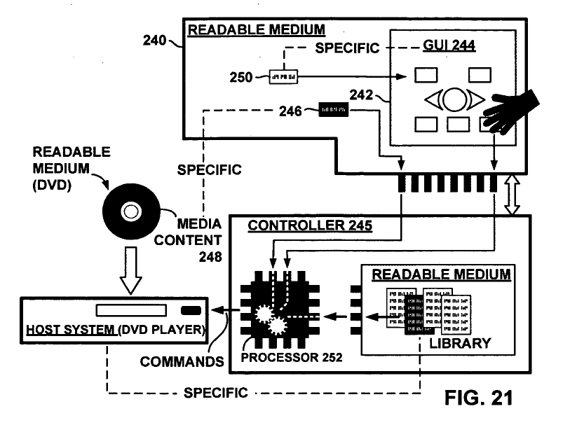

Another embodiment including a GUI in accordance with one or more aspects of the present invention is illustrated in FIG. 21. The apparatus for controlling a media event therein includes a RUI 240 having the screen 242 on which the graphical user interface (GUI) 244 is displayed. The RUI removably couples to the controller 245, and includes the control instructions 246 that are specific to the media content 248 as well as GUI defining instructions 250 for providing the GUI on the display. The controller's processor 252 reads these instructions for providing the GUI and for interpreting actuation of user inputs of the GUI and determining appropriate actions to take. In a variation thereof, the RUI may include a processor that reads the instructions for providing the GUI. The instructions read for interpreting actuation of the user inputs may be specific to particular media content.

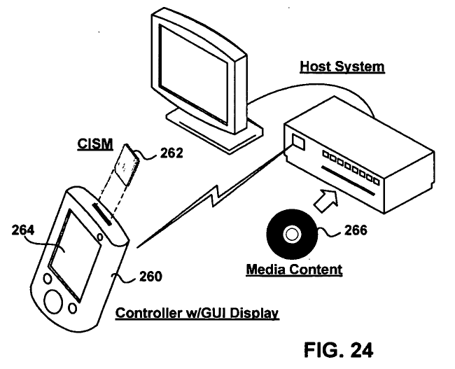

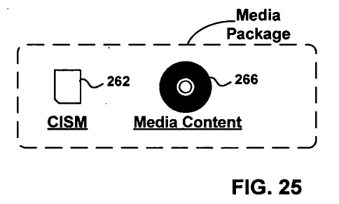

Yet another embodiment including a GUI in accordance with one or more aspects of the present invention is illustrated in FIG. 24. The apparatus for controlling a media event therein includes a graphical user interface (GUI) that is displayed on a screen of the controller, which comprises a PDA 260. The CISM comprises a memory card 262 that is removably inserted into the PDA, and includes therein the GUI defining instructions for reading by the processor of the PDA for providing the GUI on the display 264. The processor additionally reads instructions contained in the smart card for interpreting actuation of user inputs of the GUI and determining appropriate actions to take. The instructions read for interpreting actuation of the user inputs may be specific to particular media content 266. When the instructions are specific to particular media content, a commercial media package preferably includes both the smart card 262 and the media content 266 as illustrated in FIG. 25. A variation on the embodiment of FIG. 24 is shown in FIG. 26, wherein the CISM comprises network attached storage 268 from which the instructions for interpreting actuation of user inputs is downloaded/read to the PDA 270.

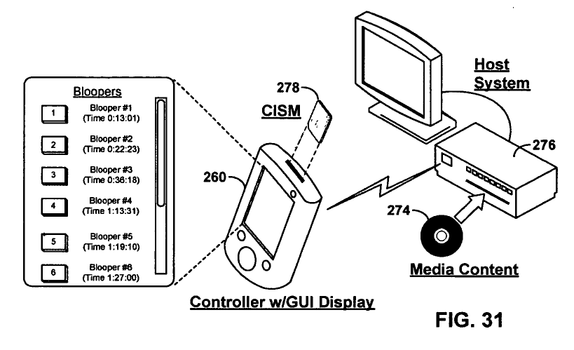

An exemplary commercial embodiment of the preferred embodiment of FIG. 24 is illustrated in FIG. 31, wherein a DVD 274 containing a movie is inserted into a DVD player 276 for viewing. A PDA 260 of the viewer serves as the controller, and wirelessly communicates with the DVD player for controlling presentation of the movie. The PDA receives a SecureDigital(™) memory card 278 that serves as the CISM containing a script. The DVD is a rental DVD from a retail store, such as BlockBuster. The CISM accompanies the DVD rental in a media package such as the type represented in FIG. 25. The CISM includes script for presenting bloopers that occur in the released version of the movie that have been identified after the movie's release. Moreover, while the script is specific to the movie, the script may be created after release of the DVD. By selecting a user input identifying a particular blooper, the controller effects presentation of the movie beginning at the timestamp of the blooper. Moreover, that ability of the controller to control presentation by the DVD player resides not in the CISM but in the library of the controller. Accordingly, so long as each user has setup his controller to work with his DVD player, i.e., identified the DVD player to the controller for proper selection by the controller of the communications protocol to use, the same CISM itself may be used universally by any user with that user's DVD player.

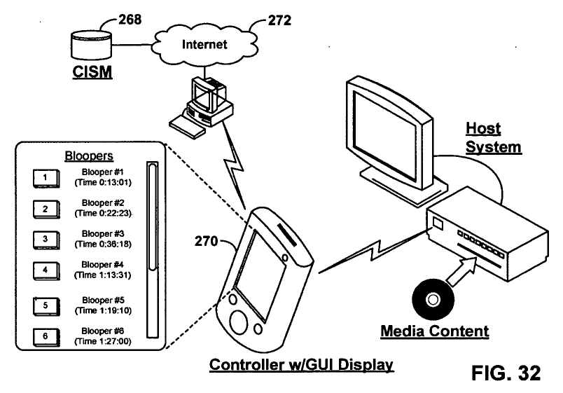

In like manner, an exemplary commercial embodiment of the preferred embodiment of FIG. 26 is illustrated in FIG. 32, wherein the CISM comprises network attached storage 268 on the Internet 272, and the user downloads the appropriate script for the DVD movie that was rented for viewing bloopers.

While the user inputs of the GUI are described as being specific to media content, in certain preferred embodiments the user inputs actually are generic to media content. In such an embodiment, for example, the user inputs appear as music track navigating buttons for use with music media content. Standard music media functions that can be provided by way of indicia and touch-responsive areas include, but are not limited to play, stop, record, forward one track, back one track, return to the first track, skip to the final track, track sequence programming, perpetual random track play, and sound volume and quality controls. In this example wherein the arrangement of the indicia of the GUI has a common appearance for use with many different music selections, one readable medium having the GUI defining instructions and the media control instructions is useful with many different particular media content selections.

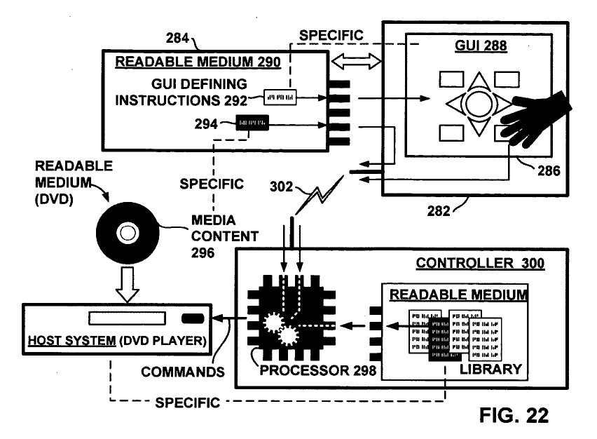

In yet another alternative of the GUI aspect of the present invention, and in accordance with the “PUI” aspect of the present invention, a peripheral user interface (PUI), which wirelessly communicates with a controller, includes a screen on which the GUI is displayed. In this variation, and as shown in FIG. 22, the PUI itself comprises a communications component 282 and a removable CISM 284. The communication component includes a display screen 286 for the GUI 288 and an interface for reading machine executable instructions of the CISM. The CISM includes the machine readable medium 290 having the machine executable instructions 292 for providing the GUI as well as the machine readable instructions 294 that are specific to the media content 296. Preferably, in this case, a processor in the PUI (not shown) executes the machine executable instructions for providing the GUI. The processor 298 of the controller 300 preferably executes the machine readable instructions specific to the media content by reading these instructions through the PUIs communications 302 with the controller.

Though the embodiment of the communications component 282 illustrated in FIG. 22 is shown to communicate wirelessly with the controller 300, another embodiment of the communications component within the scope of the present invention communicates with the controller through one or more electrically conductive connections such as one or more wires.

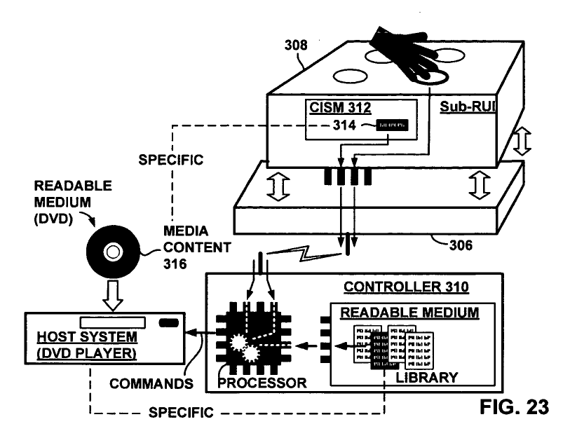

A variation of the PUI aspect is illustrated by the embodiment shown in FIG. 23, wherein the PUI comprises a communications component 306 and a subRUI 308 that removably couple together. The communications component communicates with the controller 310, and the subRUI includes the CISM 312 having the machine executable instructions 314 (i.e., the “Device Independent Instructions” or “Media Control Instructions”) that are specific to the media content 316. In certain preferred embodiments of this aspect, the subRUI also removably couples to the controller rather than just to the communications component, thereby providing an alternative to the wireless communications with the controller. That is, within the scope of the present invention, a user interface removably coupled to a controller as a RUI can be alternately removably coupled to a communications component of a PUI as a subRUI. Thus a user may learn familiarity with a particular user interface and use it by choice alternately as a RUI coupled removably to the controller or as a subRUI coupled removably to the communications component of the PUI.

Though the embodiment of the communications component 306 illustrated in FIG. 23 is shown to communicate wirelessly with the controller 310, another embodiment of the communications component within the scope of the present invention communicates with the controller through one or more electrically conductive connections such as one or more wires.

In a variation of the embodiment of FIG. 23, the CISM is separate from the subRUI and removably couples with the subRUI, communications component, and/or the controller. In commercial embodiments of this aspect, each subRUI and CISM combination is packaged with media content for which it is specifically developed to define a discrete media package. The controller and communications component may be separately sold apart or together, and each may work with any such media package.

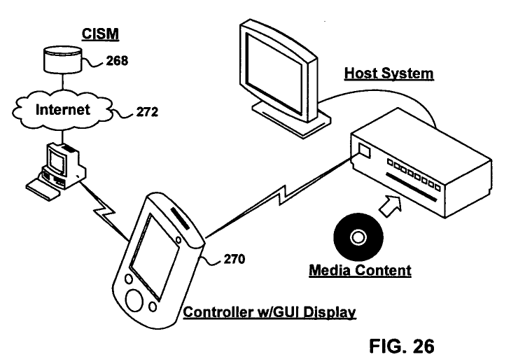

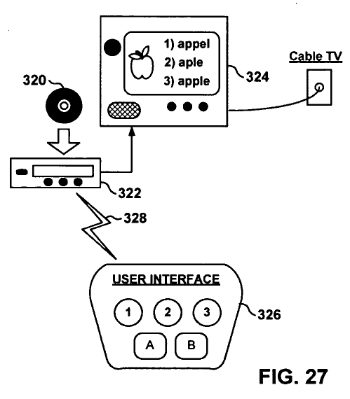

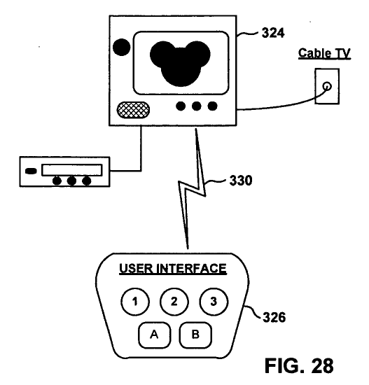

It will of course be apparent to one having ordinary skill in the art that the foregoing discloses an apparatus for controlling media events of one or more media devices. In this regard, FIGS. 27-28 illustrate an exemplary embodiment of one or more aspects of the present invention in which the apparatus for controlling a media event is utilized in conjunction with two media devices such as, for example, a DVD player and a television.

In this exemplary embodiment, the user interface is shown having a plurality of user inputs including circular buttons 1, 2, and 3 and rectangular buttons A and B. Pushing rectangular button A turns on both the DVD player and/or the television (if off), and further initiates play of any media content in the DVD player on the television if currently not playing. The playing of media content from a DVD is illustrated in FIG. 27. Pushing rectangular button B results in turning on of the television (if off), to a preset cable channel that has been selected by a parent and, thereby, approved for child viewing. Such a channel might be the Disney(™) cable programming channel or the Fox Family(™) programming channel.

Referring back now to FIG. 27, a DVD 320 having media content comprising educational programming for assisting children with spelling is inserted into the DVD player 322, and a picture of an apple is presented on the television 324. Three choices for the spelling of the word identified by the picture, i.e., “apple”, are presented in which two spellings are incorrect and one is correct. The different spellings are represented by the choices 1, 2, and 3, respectively. By selecting the appropriate circular button of the user interface, the child viewing this educational programming can select what he or she believes to be the correct spelling. Selecting either of circular buttons 1 or 2 will cause presentation of media content indicating that the spelling selected is incorrect. This is accomplished by the controller of the apparatus communicating the appropriate commands to the DVD player for presentation of this media content indicating that the spelling selected is incorrect. Selecting circular button 3 will cause presentation of media content indicating that the spelling selected is correct. This is accomplished by the controller 326 of the apparatus communicating the appropriate commands 328 to the DVD player for presentation of this media content indicating that the spelling selected is correct. This communication by the controller with the DVD player is shown in FIG. 27.

If the child becomes tired of the educational programming on spelling, the child may switch to cable programming by pushing the rectangular button B on the user interface to switch over to cable programming. In switching over to cable programming, the controller 326 of the apparatus communicates wirelessly with the television 324. This communication 330 by the controller with the television is shown in FIG. 28.

Of course, a parent may wish to limit the viewing by a child of cable programming and may wish to encourage a child to view the educational programming of a DVD by rewarding the child with the opportunity to view cable programming. In this regard, the apparatus may be programmed to permit switching to cable programming only after a predetermined event has occurred, such as a predetermined number of spellings have been correctly selected by the child. The cable programming also may be limited to a predetermined time period, after which the apparatus discontinues viewing of the cable programming. Due to the conditional programming capabilities of the apparatus, vast possibilities exist for customizing the viewing experience of the child.

As will be appreciated from the foregoing, multiple media devices can be controlled using the apparatus of one or more aspects of the present invention.

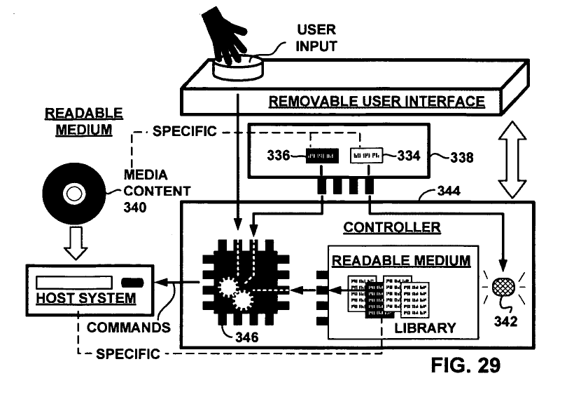

In yet another aspect of the present invention, additional media content is provided that accompanies and is presented by the apparatus for controlling the media event. A preferred embodiment of this aspect is illustrated, for example, in FIG. 29. The additional media content 334 is shown as included on the CISM 338 with the Device Independent Instructions 336. The controller 344 includes a media presentation component for presenting the additional media content. While shown as a speaker component 342 in FIG. 29, within the scope of the present invention the media presentation component could comprise a visual display screen for presentation of video media content, or both a screen and a speaker for presentation of video and audio media content.

In the illustrated embodiment of FIG. 29, the additional media content is specific to a media event. Particularly, the additional media content 334 comprises audio content specific to and related to the media content 340 to which the Device Independent Instructions 336 are specific. The audio content represents prompts and information for guiding a user in navigating the media content. The audio content can include prompts, responses, answers, instructions, questions, scoring, or indications of progress. The audio content is selected and played on the speaker component 342 of the controller 344 by the processor 346 in accordance with certain Device Independent Instructions that are executed by the processor.

In other embodiments, additional media content is not specific to particular media content. For example, exemplary additional media content that is generic to media content relates to controlling a media presentation device. In this example, a speaker component of the controller indicates to a user that a command has been issued to prompt the presentation of media content by playing an additional media content audio sample that states “Please wait, your selection will soon begin.”

In yet other embodiments, additional media content relates to media content but is not specific to a particular media content selection. In one such example, a series of educational lessons in math, spelling, and geography are available on a number of different DVD selections. Each particular DVD selection provides the series hosted by a particular animated character. This provides a child an opportunity to choose a favored character to promote the child's interest in the lessons. Additional media content is provided for presentation through a controller in conjunction with the lessons but is generic to the particular animated character hosting the lessons. In this example, the additional media content comprises audio content that is played through the controller to simulate a teacher interacting with both the child user and the chosen animated character for a simulated classroom experience wherein the animated character is a simulated classmate. The controller pronounces words in a spelling lesson and the child user and simulated classmate take turns attempting to spell the words. The child engages in a competition with the simulated classmate and learns that occasionally making mistakes is part of the learning experience of any student by seeing that the simulated classmate sometimes provides a wrong answer.

While not shown, each CISM in each of FIGS. 20-23 further could include stored therein the accompanying media content in accordance with this aspect of the present invention. In this regard, the embodiment of FIG. 20 preferably presents this accompanying media content through the GUI display screen of the controller; the embodiment of FIG. 21 preferably presents this accompanying media content through the GUI display screen of the RUI; the embodiment of FIG. 22 preferably presents this accompanying media content through the GUI display screen of the PUI; the embodiment of FIG. 23 preferably presents this accompanying media content through a media presentation component (not shown) of the controller.

By providing accompanying media content, an additional interactive experience can be provided to the user/viewer of the media event. For instance, in the given example above with reference to FIGS. 27-28, the accompanying media content may include an announcement that cable programming is available for viewing after a predetermined number of correct spelling selections have been made (this is an example of accompanying media content that is specific to the media content presented by the media device). Alternatively, a short sound clip can be played each time a user input is actuated, thereby audibly confirming to the user actuation of a user input (this is an example of accompanying media content that is not specific to the media content presented by the media device).

Due to the ability of the technology of one or more aspects of the present invention to define navigational rules for media presentations, preferred embodiments of one or more aspects of the present invention may be utilized in conjunction with both existing and well as new media content developed for use specifically for this technology.

For instance, a DVD of Disney's “The Little Mermaid,” which existed prior to the present invention, nevertheless can be viewed in accordance with one or more aspects of the present invention. An interactive viewing of the Little Mermaid is accomplished by creating appropriate script, whereby each of the user inputs on a user interface relates to appropriate corresponding video segments and, with the “push of a button,” a child can access favorite character scenes, character songs, or interface with bonus material. Moreover, using the “Accompanying Media Content” aspect of the present invention extends the interactive viewing experience without altering the existing DVD by adding audio and/or visual prompts that play from a media presentation component of the control apparatus.

Due to the ability of the technology of one or more aspects of the present invention to work with existing titles, interactive viewing in accordance with one or more aspects of the present invention across large libraries of existing titles is achieved.

In addition to working with existing media content such as CDs and DVDs, such existing media content can be combined with newly created media content (“Augmented”) in accordance with one or more aspects of the present invention to further enhance the interactive experience of a user. In this regard, for example, an existing DVD can be reproduced to include not only the original media content thereof, but additional media content specifically developed for use with the technology of one or more aspects of the present invention. The additional media content may include, for example, video prompts.

Existing media content also can be combined with other existing media content on machine readable media (“Repurposed”), such as a CDs or DVDs, for use with the technology of one or more aspects of the present invention. Of course, the repurposed media content additionally can be augmented with additional media content specifically developed for use with the technology of one or more aspects of the present invention. Such repurposed and augmented media content represents a preferred “retrofitting” method of existing media content for use with the technology of one or more aspects of the present invention, as greatly enhanced interactive viewing of the preexisting media content is thereby achieved.

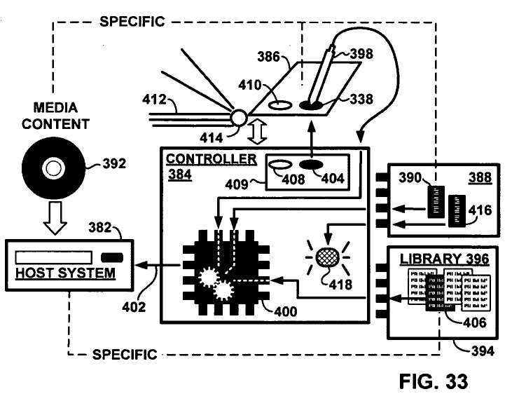

In an aspect of the present invention, as illustrated in FIG. 33, an apparatus for controlling a media event in a host system 382 includes a controller 384 and a removable user interface (RUI) 386 removably disposed on the controller. The apparatus further includes a machine readable medium 388 having machine executable instructions 390 related to a media event but not specific to any particular media device (“Device Independent Instructions”). The machine readable medium 388 having the Device Independent Instructions 390 preferably comprises a controller-independent storage medium (CISM) capable of storing computer-executable instructions, and the controller 384 preferably includes an interface for communicating with the CISM and reading the Device Independent Instructions therefrom. The apparatus further includes a machine readable medium 394 having a library 396 of selections of software instructions (“Device Dependent Instructions”), each selection being related to a particular host system and to the particular communication and control protocol thereof. The apparatus further includes a user input 398 disposed in communication with the controller 384. The controller 384 includes a processor 400 and a program executed by the processor for communicating by the controller to the host system, in a protocol of the host system, media device commands 402 relating to controlling the media event.

The program, vis-à-vis the processor, in response to actuation of the user input, performs the steps of reading and/or interpreting Device Independent Instructions, accessing the Device Dependent Instructions in the library based on the Device Independent Instructions read and/or interpreted, and communicating commands to the host system based on the Device Specific Instructions accessed from the library. That is, actuation of the user input prompts the controller to send a command to the host system for controlling the presentation of a media event. The command sent depends both on the Device Independent Instructions ,with regard to the particular media event, and on the Device Dependent Instructions, with regard to controlling the particular host system.

In FIG. 33, the user input 398 comprises a stylus disposed in electronic communication with the controller 384. The user input is actuated by placement of the stylus proximal an actuation zone 404 of the controller. The stylus receives a location dependent signal from the controller when the stylus is placed in close proximity to a location of an actuation zone. The controller interprets the location dependent signal as a particularly selected actuation of the user input and sends a command to the host system for controlling the presentation of a media event. The command sent depends on the Device Independent Instructions and the selected actuation, with regard to presentation of a particular media event, and depends on the Device Dependent Instructions, with regard to controlling a particular device of the host system to deliver the presentation.

Surface position location systems for determining a location of a stylus proximal a surface and interpreting that determination as a user input to prompt the retrieval of stored data pertaining to the determined location are described in U.S. Pat. No. 5,686,705 to Conroy, et al., (the “Conroy patent”) which is hereby incorporated herein by reference, and in U.S. Pat. No. 5,877,458 to Flowers, (the “Flowers patent”) which is hereby incorporated herein by reference.

For example, the host system 382 of FIG. 33 comprises a DVD player and the media event comprises the presentation of particular media content of a DVD 392 through any suitable media presentation device (not illustrated) of the host system such as a display screen, television, or speaker. The machine readable medium 388 comprises a CISM cartridge. The Device Independent Instructions of the CISM in this example are specific to the DVD 392 and relate to the navigation of the media content thereof for audio and/or video presentation. Furthermore, a particular selection 406 of Device Dependent Instructions of the library 396 is specific to the particular DVD player 382 and is related to a protocol for controlling the player. In this example, multiple actuation zones 408 of the controller are defined by the Device Independent Instructions 390 of the CISM 388. Each actuation zone is defined as an area of a particular location and shape within an active area 409 along a surface of the controller. Particular actuation zones are specific to particular portions of the media content of the DVD 392. Placement of the stylus proximal a particular actuation zone 404 prompts presentation of a particular portion of the media content of the DVD 392.

In other examples (not illustrated herein), placements and shapes of actuation zones are generic to media presentations but particular zones are nonetheless related to particular media events. In such an example, a collection of rectangular zones comprises a grid of cells and placement of a stylus proximal a particular cell prompts occurrence of a particular media event. The Device Independent Instructions 390 correlate particular cells to particular media events, but the layout of the grid of cells is common to various correlations and various media events.

The RUI 386 of FIG. 33 comprises an overlay for placement over the controller 384. The overlay includes graphical indicia 410 which are each related to a particular media event. The graphical indicia visually indicate to a user the locations of actuation zones for guiding the user to selectively actuate the user input 398 by placing the stylus in close proximity to a selected actuation zone 404. The selective actuation prompts the processor to interpret the Device Independent Instructions 390, and, utilizing Device Dependent Instructions, communicate a command 402 to the host system 382. A user thus selectively controls a media presentation by placing the stylus close to a selected graphical indication of the overlay for a convenient and readily understood point and play experience.

The RUI 386 of FIG. 33 further comprises a book having multiple overlay pages 412 bound by and able to turn about a coil, rings, binding, or other junction 414. Each page of the book graphically indicates actuation zones particular to the page and particular to portions of the media content of the DVD 392. As a particular page is selected by the user, particular actuation zones are defined according to the Device Independent Instructions 390 of the CISM 388.

In the embodiment illustrated in FIG. 33, the medium 394 having the library 396 comprises a CISM removably interfaced with the controller. In another embodiment the medium 394 is a component within the controller, and in yet another, is fixedly interfaced with the controller. Furthermore, in other embodiments than those illustrated in the figures, the medium 388 having the Device Independent Instructions 390 comprises or is joined with the medium 394 having the library 396. For example in one embodiment, not illustrated, a unitary memory cartridge contains Device Independent Instructions that are related to media presentation and that define actuation zones of the controller, Device Dependent Instructions related to controlling one or more media presentation devices, and additional media content. Any arrangement or configuration of one or more machine readable media providing availability of the Device Independent Instructions, Device Dependent Instructions, and additional media content is within the scope of one or more embodiments of the present invention.

In yet another aspect of the present invention, additional media content is provided that accompanies, and is presented in conjunction with, a media event of a host system. With regard to this aspect, a controller that commands a host system in the presentation of media content includes a media presentation component for presenting additional media content. A preferred embodiment of this aspect is illustrated in FIG. 33 wherein additional media content 416 comprises additional audio content that accompanies the Device Independent Instructions 390 of the CISM 388, and wherein the controller 384 includes a speaker component 418 through which the additional audio content 416 is to be audibly played to accompany the media content of DVD 392. The additional audio content 416 is selected and played on the speaker component of the controller by the processor 400 in accordance with certain Device Independent Instructions that are executed by the processor. While the media presentation component 418 of the controller 384 of FIG. 33 is shown as a speaker, another exemplary media presentation component comprises a video display screen for presentation of video media content, and yet another comprises both a screen and a speaker for presentation of video and audio additional media content.

In one example, the additional media content is specific to a media event.

Particularly, the additional media content is specific to and relates to the media content to which the Device Independent Instructions are specific. The additional media content represents prompts and information for guiding a user in navigating the educational media content of a DVD. Furthermore, the additional media content comprises audio content including audio samples, prompts, responses, answers, instructions, questions, scoring, and indications of progress in a learning experience. In this example, a speaker component of the controller indicates to a user in one instance that a correct choice has been made by playing an audio sample that sounds like a bell chime and in another instance that an incorrect choice has been made by playing an audio sample that sounds like a penalty buzzer.

In another example, the additional media content relates to attempts to control a media presentation device. For example, a speaker component of the controller indicates to a user that a command has been issued to prompt the presentation of media content by playing an additional media content audio sample that states “Please wait, your selection will soon begin.”

In yet another example, the controller detects a failure in a control attempt and alerts a user by playing an additional media content audio sample that states “Your DVD player is not responding.” In this example, the media content of a DVD includes audio content for playing through a speaker of the host system to be received by a microphone of the controller (not illustrated) and to be interpreted by the processor of the controller. An audio feedback relation between the host system and the controller requires no modification of existing commercially available host systems such as home DVD players and speaker systems. Furthermore, an audio feedback relation arrangement provides for continuous or intermittent synchronization of media content presented by a host system with additional media content presented audibly or visually by a controller. Exemplary audio content for conveying feedback signals from the host system to the controller comprises high frequency and low frequency tones that are inaudible to human ears and are not noticeable or are negligibly noticeable to a user.

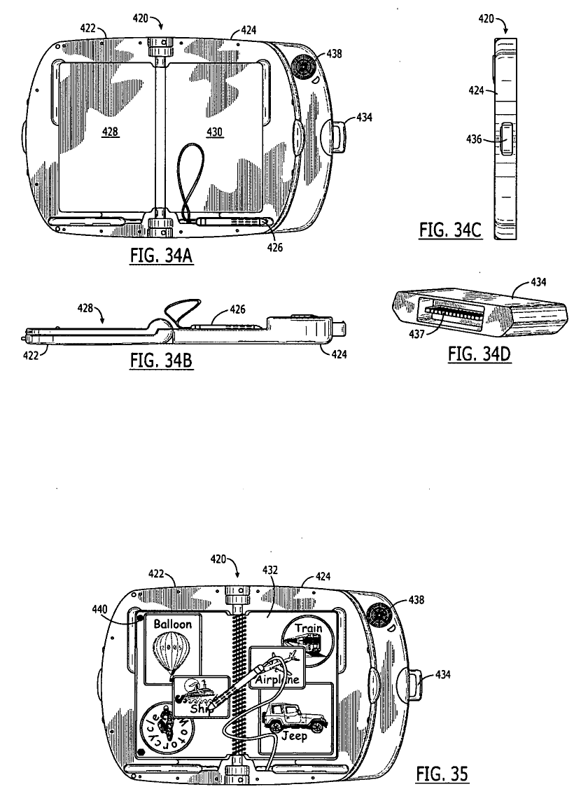

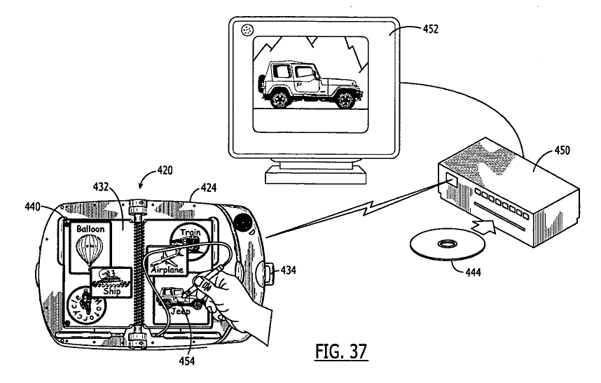

A particular commercial embodiment of an apparatus for controlling presentation of media content by a host system is shown in top view, elevation view, and side view in FIGS. 34A, 34B, and 34C, respectively. In FIG. 34A, a controller 420 comprises a first platform 422, a second platform 424, and a stylus 426 disposed in electronic communication with the controller. The first and second platforms are attached together by hinges at opposing ends of proximal margins allowing relative rotation of the platforms between a planar open configuration as shown in FIGS. 34A and 34B and a folded closed configuration as shown in FIG. 34C. The first platform 422 and second platform 424 include respective planar receiving areas 428 and 430 for receiving a RUI 432 comprising a book that overlays the controller as shown in FIG. 35 and FIG. 37. A CISM 434 in FIG. 34D, being a separate component from the controller, comprises a cartridge that houses a machine readable medium containing Device Independent Instructions 390 (FIG. 33) relating to media presentation. The controller 420 receives the cartridge as shown in FIG. 34A within a socket 436 shown in FIG. 34C. The data contents of the machine readable medium of the CISM 434 are available to a processor within the controller through a tab 437 of electrical contacts when the cartridge is inserted into the socket of the controller.

In the preferred embodiment shown in FIG. 34D, the CISM 434 contains additional media content 416 (FIG. 33) comprising additional audio content for audible presentation to a user via a speaker 438 of the second platform 424. In this preferred embodiment, multiple actuation zones of the controller are defined by the Device Independent Instructions of the CISM 434. Each actuation zone is defined as a particularly located and shaped area situated within receiving areas 428 and 430. Optionally, the CISM 434 also contains the library 396 of Device Dependent Instructions (FIG. 33). Alternatively, the library 396 is contained by a machine readable medium within the controller of FIGS. 34A-34C.

The pages of the RUI 432 book that overlays the controller 420 in FIG. 35 have graphical indicia representing actuation zones. A particular layout of actuations zones corresponds to each page of the book. Each actuation zone corresponds to a particular audio content of the additional media content contained by the CISM 434. A user indicates a pair of selected pages by placing the tip of the stylus 426 proximal a page indicator zone 440 labeled “Go.” This action prompts the controller to read the Device Independent Instructions of the CISM 434 and configure layouts of actuation zones corresponding to the pages indicated respectively for each of the first and second platforms 422 and 424. The user then selects a particular audio content by placing the tip of the stylus proximal a graphical indicator. This action prompts the controller to read the Device Independent Instructions and to audibly present the user with the additional audio content corresponding to the graphical indicator through the speaker 438.

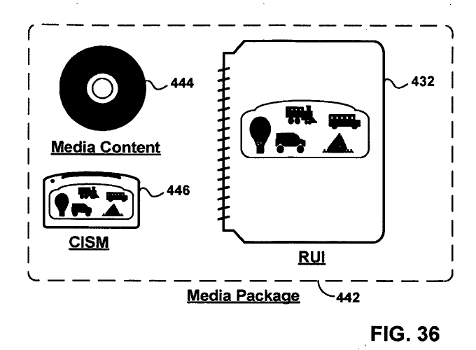

A preferred media package 442 for use in conjunction with the embodiment of the invention shown in FIG. 34A is shown in FIG. 36. The media package comprises a DVD 444 having media content for presentation on a host system such as a home DVD player 450 as shown in FIG. 37. The media package 442 further comprises a CISM cartridge 446 containing Device Independent Instructions related to the media content of the DVD 444 and containing additional audio media content for audible presentation to a user through the speaker 438 of the controller 420 shown in FIGS. 34A, 35 and 37. The media package 442 further comprises the RUI 432 comprising a book for overlaying the controller 420 as shown in FIGS. 35 and 37. In this particular example, the DVD 444 contains media content relating to various travel vehicles and additional audio media content that includes, among other things, audio samples that sound like the various travel vehicles.

In a preferred embodiment of the invention as shown in FIG. 37, a media presentation system comprises a host system for presenting the media content of the DVD 444. The host system includes a DVD player 450 in electronic communication with a display 452 for visually presenting the video media content of the DVD 444. The host system optionally further includes one or more speaker components (not shown) for audibly presenting optional audio media content of the DVD 444. The media presentation system further comprises the controller 420 having disposed thereon the RUI 432 that comprises an overlay book.

Previously to the instant of FIG. 37, a user has selected the DVD 444 to be inserted into the player and has inserted the CISM cartridge 446 into the socket of the controller 420. Furthermore, the user has selected a pair of pages of the RUI 432 and has indicated the selection to the controller by placing the tip of the stylus 426 proximal the page indicator zone 440 to prompt the controller to read the Device Independent Instructions of the cartridge 446 and configure layouts of actuation zones corresponding to graphical indicia of the open pages of the RUI as discussed with reference to FIG. 35. At the instant of FIG. 37, the stylus is placed proximal to a particular graphical indicator 454 that illustrates an all terrain vehicle and that graphically represents an actuation zone of the second platform 424 that underlies the indicator 454. This placement of the stylus prompts the controller to wirelessly communicate a command to the DVD player to cause the player to proceed in presenting media content related to the vehicle through the display 452.

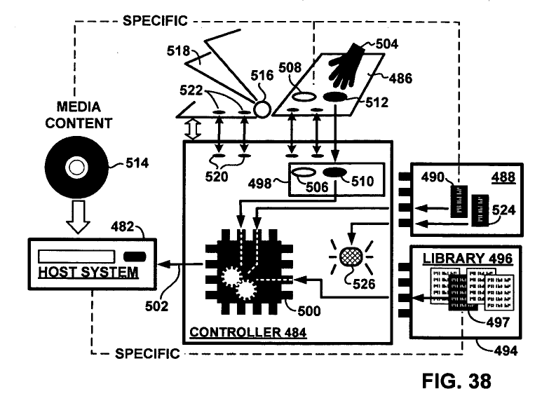

In an aspect of the present invention, as illustrated in FIG. 38, an apparatus for controlling a media event in a host system 482 includes a controller 484 and a removable user interface (RUI) 486 removably disposed on the controller. The apparatus further includes a machine readable medium 488 having machine executable instructions 490 related to a media event but not specific to any particular media device (“Device Independent Instructions”). The machine readable medium 488 having the Device Independent Instructions 490 preferably comprises a controller-independent storage medium (CISM) capable of storing computer-executable instructions, and the controller 484 preferably includes an interface for communicating with the CISM and reading the Device Independent Instructions therefrom. The apparatus further includes a machine readable medium 494 having a library 496 of selections of software instructions (“Device Dependent Instructions”), each particular selection 497 being related to a particular host system 482 and to the particular communication and control protocol thereof. The apparatus further includes a user input 498 disposed in electronic communication with the controller.

The controller 484 includes a processor 500 and a program executed by the processor for communicating by the controller to the host system, in a protocol of the host system, media device commands 502 relating to controlling the media event. The program, vis-à-vis the processor, in response to actuation of the user input, performs the steps of reading and/or interpreting Device Independent Instructions, accessing the Device Dependent Instructions in the library based on the Device Independent Instructions read and/or interpreted, and communicating commands to the host system based on the Device Dependent Instructions accessed from the library. That is, actuation of the user input prompts the controller to send a command to the host system for controlling the presentation of a media event. The command sent depends on the nature of user input and the Device Independent Instructions, with regard to the particular media event, and on the Device Dependent Instructions, with regard to controlling the particular host system.

In FIG. 38, the user input 498 comprises a position sensor disposed in electronic communication with the controller 484. The user input is actuated by placement of a selector proximal the position sensor. The selector in FIG. 38 is a human appendage such as a portion of a hand or a digit such as a finger. In other embodiments of the user input 498, the selector comprises a pointer or stylus, separate from the controller, that is held and positioned by hand or otherwise placed by a user.

In one embodiment of a user input, a position sensor comprises a plurality of pressure sensitive switches. The pressing of one or more of the switches defines a particular actuation of the user input. In this embodiment, a RUI overlays the user input and has graphical indicia representing individual switches or areas of switches to guide a user in selecting a particular actuation. In this embodiment, pressing of one or more of the switches occurs through the overlaying RUI.

In a preferred embodiment of the user input 498, the position sensor has an active range of sensitivity. The user input is actuated by a users placement of a selector 504 within the active range. One or more user input selections 506 are defined within the user input and are each selectable by the position of the placement of the selector. In this embodiment, the RUI 486 overlays the user input and has graphical indicia 508 representing input selections to guide a user in making a particular user input selection 510 favored by the user and represented by a particular graphical indication 512. The position sensor detects placement of the selector within the active range through the overlaying RUI and generates a signal that is dependent on the location of the detected placement. The controller 484 interprets the location dependent signal as an actuation of the particular user input selection 510 and sends a command 502 to the host system 482 for controlling the presentation of a media event. The command sent depends on the Device Independent Instructions 490 and the selection 510, with regard to presentation of a particular media event, and depends on particular Device Dependent Instructions 497, with regard to controlling a particular device of the host system to deliver the presentation.

For example, the media event of FIG. 38 comprises the presentation of the media content 514 of a DVD and the host system 482 comprises a DVD player. The graphical indication 512 represents a particular portion of the media content and the command 502 prompts the player to present the portion in response the user actuating the user input selection 510.

A position sensor for detecting the presence of a selector within an active range, for determining the location of the selector, and for generating a signal associated with a selection according to the location of the selector is described in U.S. patent application Ser. No. 10/448,583 of Kelley et al (the “Kelley application”), filed on May 30, 2003, as published under Pub. No. US2004/0043365A1 on Mar. 4, 2004, which patent application is hereby incorporated herein by reference in its entirety.

Though the user input 498 of FIG. 38 is illustrated as a component of the controller 484, other embodiments within the scope of the present invention include user inputs that are peripheral to the controller and are in communication with the controller via wireless signals or via one or more wires.

In the preferred embodiment illustrated in FIG. 38, the RUI 486 comprises a book 516 of overlay pages 518 each having graphical indicia representing user input selections. One or more page identification sensors 520 are disposed in electronic communication with the controller 484. Furthermore, the book 516 comprises one or more page identifiers 522 sensed by the sensors 520 for determination by the controller of the particular two page spread configuration of the book when disposed on the controller and opened to a pair of opposing pages. Page identifiers and page identification sensors are described in conjunction with a book of overlay pages in the Kelley application.

As illustrated in FIG. 38, additional media content 524 accompanies the Device Independent Instructions 488 of the medium 388, and the controller 484 includes a component 526 through which the additional media content is to be presented to accompany the media content 514. While the media presentation component 518 of the controller 484 of FIG. 38 is shown as a speaker, another exemplary media presentation component comprises a video display screen for presentation of video media content, and yet another comprises both a screen and a speaker for presentation of video and audio additional media content.

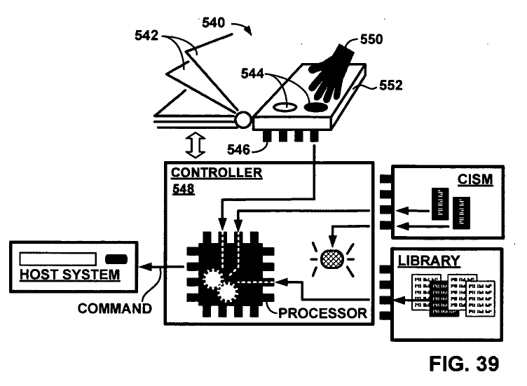

In FIG. 39, the RUI 540, having various embodiments, comprises a book 516 of pages 542 and further comprises user inputs 544 graphically represented by indicia on the pages. The RUI in this embodiment has an interface 546 for electronic communication with the controller 548. Though the interface is illustrated in FIG. 39 as multiple electrical contacts received by a port of the controller, any suitable arrangement comprising a wireless transmitter or any number of wires is within the scope of the present invention. Optionally each page comprises user inputs for actuation by a selector 550. Alternatively, a base page 552 comprises the user inputs and other pages of the book, having graphical indicia, selectively overlay the base page and guide the user in placing the selector to actuate a user input. A RUI comprising a position sensor as described in the Kelley application, a RUI comprising a surface position location system as described in the Conroy patent and in the Flowers patent, and a RUI comprising a plurality of pressure sensitive switches are all within the scope of at least one embodiment of the present invention. Indeed and any suitable arrangement for generating signals according to a selective actuation by a user is within the scope of at least one embodiment of the RUI of the present invention.

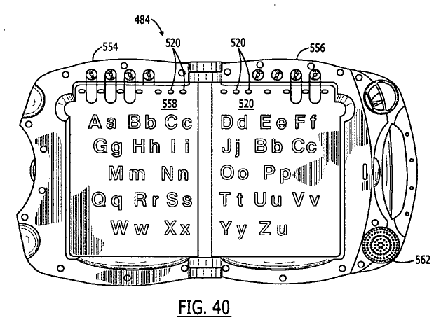

A particular commercial embodiment of the controller 484 of FIG. 38 is shown in FIG. 40. The controller 484 comprises a first platform 554 and a second platform 556 attached together by hinges at opposing ends of proximal margins allowing relative rotation of the platforms between a planar open configuration as shown and a folded closed configuration (not illustrated). The first platform 554 and second platform 556 include respective planar receiving areas 558 and 560 for receiving the RUI 486 comprising a book that overlays the controller as shown in FIG. 38. Page identification sensors 520 are shown in each of the receiving areas. A user input comprising a position sensor as described in the Kelley application underlies the planar receiving areas. Use of this commercial embodiment for controlling a media event in a host system is illustrated in FIG. 38 and is described herein with reference thereto.

In FIG. 40, additional media content that is contained within a machine readable medium within the controller includes audio content for audibly playing through a speaker component 562. The additional media content contained in this embodiment relates to alphabetic lessons and is selectively played upon actuation of user inputs represented by graphical indicia of the planar receiving areas. The additional media content relating to alphabetic lessons is available to a user of this controller without a RUI overlaying the controller or a CISM interfaced with the controller.

The descriptions set forth above are not intended, nor are to be construed, to limit the general breadth of the present invention or otherwise to exclude any such other embodiments, adaptations, variations, modifications and equivalent arrangements, the present invention being limited only by the claims appended in an issued patent therefor, and the equivalents thereof.

1. A media presentation system, comprising,
(a) a host system for presenting media content, said host system including a machine readable medium containing the media content, and
(b) an apparatus for controlling presentation of the media content by said host system, said apparatus comprising,
(i) a removable user interface (RUI),
(ii) a user input,
(iii) a controller, said RUI removably attached to said controller, said controller comprising,
(A) a processor,
(B) a program in machine readable medium executed by said processor that interprets machine executable instructions, and
(iv) a machine readable medium having a library of machine executable instructions that are accessible to said program for communicating to said host system, in a protocol of said host system, commands relating to presentation of the media content (Device Dependent Instructions), and
(v) a controller-independent storage medium (CISM) comprising a machine readable medium containing machine executable instructions relating to media presentation (Device Independent Instructions), said CISM being a separate component from said controller,
(c) wherein said program executed by said processor performs a method comprising the steps of,
(i) in response to actuation of said user input, reading one or more of said Device Independent Instructions,
(ii) based on one or more of said read Device Independent Instructions, accessing one or more of said Device Dependent Instructions, and
(iii) based on said accessed machine executable instructions of said library, communicating one or more of said commands to said host system.

2. The media presentation system of claim 1, wherein the Device Independent Instructions are specific to the media content presented by said host system.

3. The media presentation system of claim 1, wherein said controller includes said user input.

4. The media presentation system of claim 1, wherein said user input comprises a stylus disposed in electronic communication with said controller.

5. The media presentation system of claim 1, wherein said RUI comprises an overlay for placement over said controller, said overlay including thereon printed graphical indicia.

6. The media presentation system of claim 1, wherein said RUI comprises a book.

7. The media presentation system of claim 1, wherein,
(i) said RUI comprises a book having graphical indicia representing actuation zones,
(ii) said user input comprises a stylus disposed in electronic communication with said controller, and
(iii) said user input is actuated by placement of said stylus proximal one of the actuation zones.

8. The media presentation system of claim 1, wherein said machine readable medium of said CISM contains machine executable instructions for defining actuation zones, and wherein said user input is actuated by placement of said user input proximal one of the actuation zones.

9. The media presentation system of claim 1, wherein said CISM comprises a cartridge, and said controller includes an interface for removably receiving said cartridge for reading of said Device Independent Instructions therefrom.

10. The media presentation system of claim 1, wherein said CISM further comprises said machine readable medium having a library of machine executable instructions.

11. The media presentation system of claim 1, wherein said CISM further includes accompanying media content for presenting in conjunction with the presentation of the media content by the host system.

12. The media presentation system of claim 11, wherein said controller further includes a media presentation component for presenting said accompanying media content.

13. The media presentation system of claim 11, wherein said media presentation component of said controller comprises a speaker.

14. The media presentation system of claim 1, wherein said controller further comprises said machine readable medium having a library of machine executable instructions.

15. The media presentation system of claim 1, wherein said controller comprises an interface for removably receiving said machine readable medium having a library of machine executable instructions.

16. The media presentation system of claim 1, wherein said host system includes a DVD player, and said machine readable medium containing the media content presented by said host system comprises a DVD.

17. The media presentation system of claim 1, wherein said user input comprises multiple selectable user inputs each corresponding to particular said Device Independent Instructions.

18. The media presentation system of claim 1, wherein,
(i) said user input comprises a position sensor disposed in electronic communication with said controller, and
(ii) said user input is actuated by placement of a selector proximal the position sensor.

19. The media presentation system of claim 18, wherein said selector comprises a finger.

20. The media presentation system of claim 18, wherein said selector comprises a stylus separate from the controller.

21. The media presentation system of claim 18, wherein,
(i) said position sensor comprises a plurality of pressure-sensitive switches, and
(ii) said user input is actuated by said selector pressing at least one said pressure-sensitive switch.

22. The media presentation system of claim 18, wherein,
(i) said position sensor has an active range, and
(ii) said user input is actuated by placement of said selector within said active range.

23. The media presentation system of claim 18, wherein said RUI comprises said user input.

24. The media presentation system of claim 18, wherein said controller comprises said user input.

25. The media presentation system of claim 24, wherein,
(i) said RUI comprises an overlay having graphical indicia representing said user input
(ii) said user input is actuated through said overlay.

26. The media presentation system of claim 25, wherein said user input is actuated through said overlay by placement of a selector proximal said graphical indicia.

27. The media presentation system of claim 18, wherein,
(i) said RUI comprises a book of overlays having graphical indicia representing user input selections, and
(ii) said apparatus further comprises a page identification sensor disposed in electronic communication with said controller.

28. The media presentation system of claim 27, wherein said book comprises a page identifier.

29. In a media presentation system having a media device for presenting media content, an invention comprising an apparatus for controlling presentation of the media content by the media device, comprising,
(a) a removable user interface (RUI),
(b) a user input,
(c) a controller, said RUI removably attached to said controller, said controller comprising,
(i) a processor, and
(ii) a program in machine readable medium executed by said processor that interprets machine executable instructions, and
(iii) a machine readable medium having a library of machine executable instructions that are accessible to said program for communicating to said host system, in a protocol of said host system, commands relating to presentation of the media content (Device Dependent Instructions), and
(d) a controller-independent storage medium (CISM) comprising a machine readable medium containing machine executable instructions relating to media presentation (Device Independent Instructions), said CISM being a separate component from said controller,
(e) wherein said program executed by said processor performs a method comprising the steps of,
(i) in response to actuation of said user input, reading one or more of said Device Independent Instructions,
(ii) based on one or more of said read Device Independent Instructions, accessing one or more of said Device Dependent Instructions, and
(iii) based on said accessed machine executable instructions of said library, communicating one or more of said commands to said host system.

30. An apparatus for controlling a media event, comprising,
(a) a removable user interface (RUI),
(b) a user input,
(c) a controller, said RUI removably attached to said controller, said controller comprising,
(i) a processor, and
(ii) a program in machine readable medium executed by said processor that interprets machine executable instructions, and
(d) a machine readable medium having a library of machine executable instructions that are accessible to said program for communicating to said host system, in a protocol of said host system, commands relating to the media event (Device Dependent Instructions), and
(e) a controller-independent storage medium (CISM) comprising a machine readable medium containing machine executable instructions relating to the media event (Device Independent Instructions), said CISM being a separate component from said controller,
(f) wherein said program executed by said processor performs a method comprising the steps of,
(i) in response to actuation of said user input, reading one or more of said Device Independent Instructions,
(ii) based on one or more of said read Device Independent Instructions, accessing one or more of said Device Dependent Instructions, and
(iii) based on said accessed machine executable instructions of said library, communicating one or more of said commands to said host system.

31. A media package, comprising,
(a) a machine readable medium containing particular media content for presentation thereof by a media device,
(b) a removable user interface (RUI) removably attachable to a controller of the media device, said RUI including graphical indicia thereon that are specific to the particular media content, and
(c) a controller-independent storage medium (CISM) comprising a machine readable medium containing machine executable instructions that are specific to the particular media content (Device Independent Instructions), but that are independent of the media device.

32. The media package of claim 31, wherein said machine readable medium containing the particular media content comprises a DVD for presentation thereof by a DVD player.

33. The media package of claim 31, wherein said RUI comprises an overlay.

34. The media package of claim 31, wherein said RUI comprises a book.

35. The media package of claim 31, wherein said RUI includes said CISM.

36. The media package of claim 31, wherein said CISM is a separate component from said RUI.

37. The media package of claim 31, wherein said CISM comprises a cartridge.
